(19) United States
(12) Patent Application Publication
(10) Pub. No.: US 2017/0064953 A1
(43) Pub. Date: Mar. 9, 2017

(54) HERBICIDAL COMPOSITIONS CONTAINING 4-AMINO-3-CHLORO-6-(4-CHLORO-2-FLUORO-3-METHOXYPHENYL) PYRIDINE-2-CARBOXYLIC ACID OR A DERIVATIVE THEREOF, A TRIAZOLOPYRIMIDINE SULFONAMIDE HERBICIDE OR A DERIVATIVE THEREOF, AND GLYPHOSATE OR A DERIVATIVE THEREOF

(71) Applicant: Dow AgroSciences LLC, Indianapolis, IN (US)

(72) Inventors: Christopher J. Voglewede, Calgary (CA); Richard K. Mann, Indianapolis, IN (US); Rodrigo Neves, Buenos Aires (BR); Baez Buchanan Marcos, Maipu (AR); Rafael Frene, Buenos Aires (AR); Kent Davies, Indianapolis, IN (US); Luiz Henrique Zobiole, Toledo (BR)

(73) Assignee: Dow AgroSciences LLC, Indianapolis, IN (US)

(21) Appl. No.: 15/259,448

(22) Filed: Sep. 8, 2016

Related U.S. Application Data
(60) Provisional application No. 62/273,658, filed on Dec. 31, 2015.
(60) Provisional application No. 62/215,283, filed on Sep. 8, 2015.
(60) Provisional application No. 62/215,919, filed on Sep. 9, 2015.

(51) Int. Cl. A01N 43/40; A01N 57/20; A01N 43/90

(52) U.S. Cl. CPC A01N 43/40; A01N 43/90; A01N 57/20

(57) ABSTRACT

Herbicidal compositions and methods using a combination of (a) a compound of formula (I):

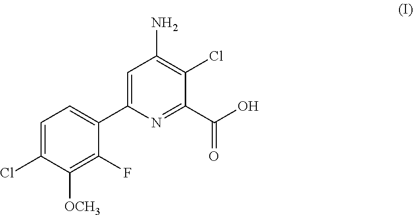 [SMILES: COc1c(Cl)ccc(-c2cc(N)c(Cl)c(C(=O)O)n2)c1F]

or an agriculturally acceptable salt or ester thereof, (b) a triazolopyrimidine sulfonamide herbicide or an agriculturally acceptable salt or ester thereof, and (c) glyphosate or an agriculturally acceptable salt or ester thereof provide control of undesirable vegetation in soybean, cotton, sunflower, winter/spring oilseed rape, winter/spring canola, vegetables, ornamentals, rice, wheat, teff, triticale, barley, oats, rye, sorghum, corn/maize, sunflower, row crops, pastures, grasslands, rangelands, fallowland, fallow bed, sugarcane, turf, tree and vine orchards, aquatics, forestry, industrial vegetation management (IVM) and rights-of-way; for the burndown and control of weeds in fallow fields and fallow beds between the planting of crops, such as soybean, corn, cotton sunflower, cereals, rice, winter/spring oilseed rape, winter/spring canola, corn/maize and sorghum; and for the control of weeds just prior to or after planting soybeans.

### CROSS REFERENCE TO RELATED APPLICATIONS

This application claims the benefit of U.S. Provisional Patent Applications Ser. Nos. 62/215,283 filed Sep. 8, 2015, 62/215,919 filed Sep. 8, 2015, and 62/273,658 filed Dec. 29, 2015, which are expressly incorporated by reference herein.

### BACKGROUND

The protection of crops from weeds and other vegetation which inhibit crop growth is a constantly recurring problem in agriculture. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use. However, there remains a need for compositions and methods that are effective in controlling undesirable vegetation.

### SUMMARY

Provided herein are herbicidal compositions containing a herbicidally effective amount of (a) a compound of the formula (I)

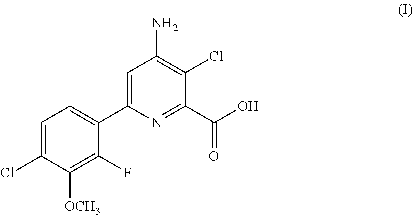 [SMILES: COc1c(Cl)ccc(-c2cc(N)c(Cl)c(C(=O)O)n2)c1F]

or an agriculturally acceptable salt or ester of thereof and (b) a triazolopyrimidine sulfonamide herbicide or an agriculturally acceptable salt or ester thereof, and (c) glyphosate or an agriculturally acceptable salt thereof. In some embodiments, (b) includes, but is not limited to, cloransulam, diclosulam, florasulam, flumetsulam, metosulam, penoxsulam, or pyroxsulam, agriculturally acceptable salts or esters thereof, or combinations thereof. The compositions may also contain one or more agriculturally acceptable safeners, adjuvants and/or carriers. In some embodiments, the activity of the mixtures is greater than the sum of the activity of the individual active ingredients.

The three-way mixture can be prepared as a tank mix or premix. For example, a tank mix or premix containing the compound of formula (I) or a salt or ester thereof and a triazolopyrimidine sulfonamide herbicide or a salt or ester thereof can be mixed with glyphosate to form the three-component tank mix. In this embodiment, the tank mix, premix or concentrate of the compound of formula (I) and a triazolopyrimidine sulfonamide herbicide or a salt or ester thereof and glyphosate can be packaged and sold separately, can be copackaged together in separate containers or can be formulated together in one package.

In other embodiments, a premix or concentrate containing the compound of formula (I) or a salt or ester thereof and glyphosate or a salt thereof can be mixed in a tank or container with a triazolopyrimidine sulfonamide herbicide or a salt or ester thereof to form the tank mix. In this embodiment, the premix or concentrate of the compound of formula (I) and glyphosate and a triazolopyrimidine sulfonamide herbicide or a salt or ester thereof can be packaged and sold separately, or can be copackaged together in separate containers, or can be formulated together in one package.

In still other embodiments, a premix containing all three active ingredients can be prepared and sold.

The ratio of the compound of formula (I) to a triazolopyrimidine sulfonamide herbicide or a salt or ester thereof in the premix is from about 1:200 to about 200:1; from about 1:40 to about 30:1, and from about 1:15 to about 10:1. The ratio of the compound of formula (I) to diclosulam in the premix is from about 1:200 to about 20:1; from about 1:30 to about 6:1, and from about 1:6 to about 2:1. The ratio of the compound of formula (I) to florasulam in the premix is from about 1:60 to about 200:1; from about 1:7.5 to about 30:1, and from about 1:1.25 to about 6.7:1. The ratio of the compound of formula (I) to pyroxsulam in the premix is from about 1:100 to about 100:1; from about 1:12.5 to about 15:1, and from about 1:3.75 to about 2.1:1. The ratio of the compound of formula (I) to cloransulam or flumetsulam in the premix is from about 1:200 to about 6.25:1; from about 1:40 to about 3:1, and from about 1:15 to about 1.33:1. The ratio of the compound of formula (I) to metosulam in the premix is from about 1:100 to about 50:1; from about 1:15 to about 17:1, and from about 1:5 to about 10:1. The ratio of the compound of formula (I) to penoxsulam in the premix is from about 1:200 to about 20:1; from about 1:25 to about 6:1, and from about 1:9.6 to about 2.67:1.

The ratio of the compound of formula (I) to a triazolopyrimidine sulfonamide herbicide or a salt or ester thereof to glyphosate in the tank mix is from about 1:16:560 to about 1:1:67, from about 1:5:280 to about 1:1:75, and from about 1:3:168 to about 3.2:1:269. The ratio of the compound of formula (I) plus a triazolopyrimidine sulfonamide herbicide or a salt or ester thereof to glyphosate in the tank mix is from about 1:3360 to 0.54:1, from about 1:747 to 0.196:1, and from about 1:210 to 0.112:1.

The ratio of the compound of formula (I) to diclosulam to glyphosate in the tank mix is from about 1:5:560 to about 1:2:67, from about 1:2.5:280 to about 1:2:75, and from about 1:2:168 to about 1:1.5:84. The ratio of the compound of formula (I) plus diclosulam to glyphosate in the tank mix is from about 1:1120 to about 0.54:1, from about 1:320 to about 0.161:1, and from about 1:112 to about 0.06:1.

The ratio of the compound of Formula I to florasulam to glyphosate in the tank mix is from about 2:1:1120 to about 1.67:1:112, from about 2:1:560 to about 2:1:149, and from about 1.67:1:280 to about 3.2:1:268. The ratio of the compound of formula (I) plus florasulam to glyphosate in the tank mix is from about 1:4480 to about 0.286:1, from about 1:747 to about 0.08:1, and from about 1:210 to about 0.031:1.

The ratio of the compound of Formula I to pyroxsulam to glyphosate in the tank mix is from about 1:1:560 to about 1:1:67, from about 1:1:280 to about 1.2:1:90, and from about 1:1.92:168 to about 1.07:1:90. The ratio of the compound of formula (I) plus pyroxsulam to glyphosate in the tank mix is from about 1:3360 to about 0.357:1, from about 1:560 to about 0.098:1, and from about 1:115 to about 0.046:1.

The ratio of the compound of Formula I to cloransulam or flumetsulam to glyphosate in the tank mix is from about 1:16:560 to about 1:2:67.2, from about 1:5:280 to about 1:2.67:75, and from about 1:3:168 to about 1:3.75:84. The ratio of the compound of formula (I) plus cloransulam or flumetsulam to glyphosate in the tank mix is from about 1:395 to about 0.536:1, from about 1:187 to about 0.196:1, and from about 1:84 to about 0.113:1.

The ratio of the compound of Formula I to metosulam to glyphosate in the tank mix is from about 1:2:560 to about 1:1:67, from about 1.14:1:320 to about 1:1:75, and from about 2.5:1:420 to about 1:1.25:84. The ratio of the compound of formula (I) plus metosulam to glyphosate in the tank mix is from about 1:2240 to about 0.357:1, from about 1:678 to about 0.125:1, and from about 1:240 to about 0.054:1.

The ratio of the compound of Formula I to penoxsulam to glyphosate in the tank mix is from about 1:5:560 to about 1:2:67, from about 1:2.5:280 to about 1:1.67:75, and from about 1:1.5:168 to about 1:2.4:84. The ratio of the compound of formula (I) plus penoxsulam to glyphosate in the tank mix is from about 1:1120 to about 0.446:1, from about 1:389 to about 0.161:1, and from about 1:168 to about 0.083:1.

Also provided are methods of controlling undesirable vegetation comprising applying (a) a compound of formula (I) or an agriculturally acceptable ester or salt thereof, (b) a triazolopyrimidine sulfonamide herbicide or an agriculturally acceptable salt or ester thereof, and (c) glyphosate or an agriculturally acceptable ester or salt thereof.

### DETAILED DESCRIPTION

### I. Definitions

As used herein, control of or controlling undesirable vegetation means killing or preventing the growth of the vegetation, or causing some other adverse modifying effect to the vegetation e.g., necrosis, chlorosis, stunting, deviations from natural growth or development, regulation, desiccation, retardation, and the like.

As used herein, herbicide and herbicidal active ingredient mean a compound that controls undesirable vegetation when applied in an appropriate amount.

As used herein, a herbicidally effective or vegetation controlling amount is an amount of herbicidal active ingredient the application of which controls the relevant undesirable vegetation.

As used herein, applying a herbicide or herbicidal composition means delivering it directly to the targeted vegetation or to the locus thereof or to the area where control of undesired vegetation is desired. Methods of application include, but are not limited to pre-emergence, post-emergence, foliar and soil applications. Described herein are methods of controlling undesirable vegetation by applying certain herbicide combinations or compositions.

As used herein, plants and vegetation include, but are not limited to, dormant seeds, germinant seeds, emerging seedlings, plants emerging from vegetative propagules, immature vegetation, mature vegetation, reproductive vegetation and established vegetation.

As used herein, immature vegetation refers to small vegetative plants prior to reproductive stage, and mature vegetation refers to vegetative plants during and after reproductive stage.

As used herein, glyphosate tolerance refers to soybeans, corn, or cotton that is genetically modified to be tolerant to glyphosate. Glyphosate tolerance can be provided, for example, by the CP4 gene (U.S. Pat. No. 5,627,061 A) or 2mEPSPS (U.S. Pat. No. 6,566,587 B1) as shown herein; however, glyphosate tolerance could also be conferred within the scope of glyphosate-, 2,4-D-, and glufosinate-tolerant soybeans, corn, or cotton described herein by other genes providing transgenic crop tolerance to glyphosate [e.g., AroA and other Class II EPSPS (U.S. Pat. No. 7,893,234 B2); GLG23 and other Class III EPSPS (U.S. Pat. No. 7,700,842 B2); GAT (U.S. Pat. No. 7,405,074 B2), Gox (U.S. Pat. No. 5,463,175 A), or other glyphosate-metabolism gene; or DGT-28 or other Class IV EPSPS (U.S. Patent Application Publication 20130217577A1)] and are considered to be included within the scope of the 2,4-D-, glyphosate- and glufosinate-tolerant soybeans, corn, or cotton described herein.

### II. Mixtures

Compositions containing the compound of formula (I) or a salt or ester thereof, a triazolopyrimidine sulfonamide herbicide or a salt or ester thereof, and glyphosate or a salt or ester thereof are described herein. The composition can be in the form of a tank mix, premix, or co-pack of 1 or more compositions mixed with 1 or more separate compositions containing the compound of formula (I) or a salt or ester thereof, a triazolopyrimidine sulfonamide herbicide or a salt or ester thereof, and glyphosate or a salt or ester thereof. The tank mix can be prepared by mixing a premix, co-pack or tank mix or concentrate containing the compound of formula (I) and a triazolopyrimidine sulfonamide herbicide or glyphosate. In some embodiments, (b) includes, but is not limited to, cloransulam, diclosulam, florasulam, flumetsulam, metosulam, penoxsulam, or pyroxsulam, agriculturally acceptable salts or esters thereof, or combinations thereof.

Agriculturally acceptable salts and esters refer to salts and esters that exhibit herbicidal activity, or that are or can be converted in plants, water, or soil to the referenced herbicide. Exemplary agriculturally acceptable esters are those that are or can by hydrolyzed, oxidized, metabolized, or otherwise converted, e.g., in plants, water, or soil, to the corresponding carboxylic acid which, depending on the pH, may be in the dissociated or undissociated form.

Exemplary salts include those derived from alkali or alkaline earth metals and those derived from ammonia and amines Exemplary cations include sodium, potassium, magnesium, and ammonium cations of the formula:

R¹R²R³R⁴N+

wherein R¹, R², R³ and R⁴ each, independently represents hydrogen or C₁-C₁₂ alkyl, C₃-C₁₂ alkenyl or C₃-C₁₂ alkynyl, each of which is optionally substituted by one or more hydroxy, C₁-C₄ alkoxy, C₁-C₄ alkylthio or phenyl groups, provided that R¹, R², R³ and R⁴ are sterically compatible. Additionally, any two of R¹, R², R³ and R⁴ together may represent an aliphatic difunctional moiety containing one to twelve carbon atoms and up to two oxygen or sulfur atoms. Salts can be prepared by treatment with a metal hydroxide, such as sodium hydroxide, with an amine, such as ammonia, trimethylamine, diethanolamine, 2-methylthiopropylamine, bisallylamine, 2-butoxyethylamine, morpholine, cyclododecylamine, or benzylamine or with a tetraalkylammonium hydroxide, such as tetramethylammonium hydroxide or choline hydroxide.

Exemplary esters include those derived from C₁-C₁₂ alkyl, C₃-C₁₂ alkenyl, C₃-C₁₂ alkynyl or C₇-C₁₀ aryl-substituted alkyl alcohols, such as methyl alcohol, isopropyl alcohol, 1-butanol, 2-ethylhexanol, butoxyethanol, methoxypropanol, allyl alcohol, propargyl alcohol, cyclohexanol or unsubstituted or substituted benzyl alcohols. Benzyl alcohols may be substituted with from 1-3 substituents independently selected from halogen, C₁-C₄ alkyl or C₁-C₄ alkoxy. Esters can be prepared by coupling of the acids with the alcohol using any number of suitable activating agents such as those used for peptide couplings such as dicyclohexylcarbodiimide (DCC) or carbonyl diimidazole (CDI); by reacting the acids with alkylating agents such as alkylhalides or alkylsulfonates in the presence of a base such as triethylamine or lithium carbonate; by reacting the corresponding acid chloride of an acid with an appropriate alcohol; by reacting the corresponding acid with an appropriate alcohol in the presence of an acid catalyst or by transesterification.

Weight ratios of mixtures are calculated using the acid equivalent weight(s) of any compounds in the mixture that are salts or esters. Weight ratios are expressed in units of weight to weight (grams (g) to g, grams acid equivalent per hectare (g ae/ha) to g ae/ha, grams acid equivalent per hectare (g ae/ha) to grams active ingredient per hectare (g ai/ha), or grams active ingredient per hectare (g ai/ha) to g ai/ha).

The combination of compound (I) or agriculturally acceptable salt or ester thereof, a triazolopyrimidine sulfonamide herbicide or a salt or ester thereof, and glyphosate is more effective than the individual herbicidal active ingredients.

A. Halauxifen

The compound of formula (I) has the following structure:

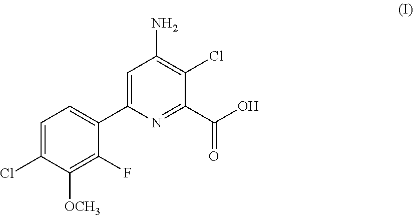 [SMILES: COc1c(Cl)ccc(-c2cc(N)c(Cl)c(C(=O)O)n2)c1F]

The compound of formula (I) can be identified by the name 4-amino-3-chloro-6-(4-chloro-2-fluoro-3-methoxyphenyl)pyridine-2-carboxylic acid and has been described in U.S. Pat. No. 7,314,849 (B2), which is incorporated herein by reference in its entirety. It is also referred to as halauxifen. The methyl ester is known as halauxifen-methyl and is sold commercially as ARYLEX®.

In certain embodiments of the compositions and methods described herein, the compound of formula (I), i.e., the carboxylic acid, is employed. In certain embodiments, a carboxylate salt of the compound of formula (I) is employed. In certain embodiments, an arylalkyl or alkyl ester is employed. In certain embodiments, a benzyl, substituted benzyl, or C₁-C₄ alkyl, e.g., methyl or n-butyl ester is employed. In certain embodiments, the methyl ester, benzyl ester, or potassium salt is employed.

Exemplary uses of the compound of the formula (I) include controlling undesirable vegetation, including e.g., grass, broadleaf and sedge weeds, in cereal and multiple perennial and non-cropping situations.

B. Triazolopyrimidine Sulfonamides

Triazolopyrimidine sulfonamides are a chemical class of herbicides having a triazolopyrimidine sulfonamide core structure. Exemplary herbicidal uses of triazolopyrimidine sulfonamides include, but are not limited to, use for control of nuisance sedge, broadleaf and grass weeds.

Diclosulam, shown below, is N-(2,6-dichlorophenyl)-5-ethoxy-7-fluoro[1,2,4]triazolo[1,5-c]pyrimidine-2-sulfonamide. Its herbicidal activity is described in The Pesticide Manual. Exemplary uses of diclosulam include, but are not limited to, weed control in peanuts, soybeans and sugar cane.

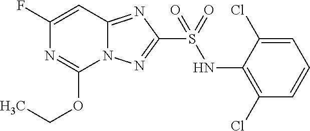 [SMILES: CCOc1nc(F)cc2nc(S(=O)(=O)Nc3c(Cl)cccc3Cl)nn12]

Cloransulam, shown below, is 3-chloro-2-[[(5-ethoxy-7-fluoro[1,2,4]triazolo[1,5-c]pyrimidin-2-yl)sulfonyl]amino]benzoic acid.

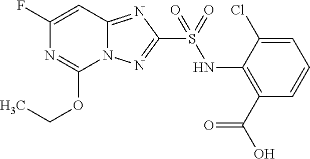 [SMILES: CCOc1nc(F)cc2nc(S(=O)(=O)Nc3c(Cl)cccc3C(=O)O)nn12]

Cloransulam-methyl is methyl 3-chloro-2-[[(5-ethoxy-7-fluoro[1,2,4]triazolo[1,5-c]pyrimidin-2-yl)sulfonyl]amino]benzoate and has the following structure:

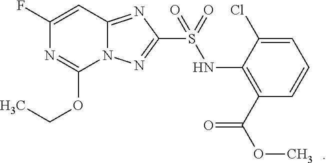 [SMILES: CCOc1nc(F)cc2nc(S(=O)(=O)Nc3c(Cl)cccc3C(=O)OC)nn12]

Its herbicidal activity is described in The Pesticide Manual. Exemplary uses of cloransulam-methyl include, but are not limited to, post-emergence control of broadleaf weeds in soybeans and other broadleaf crops.

Florasulam, shown below, is N-(2,6-difluorophenyl)-8-fluoro-5-methoxy[1,2,4]triazolo[1,5-c]pyrimidine-2-sulfonamide and has the following structure:

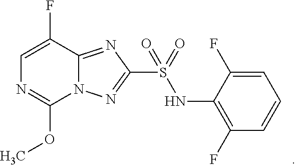 [SMILES: COc1ncc(F)c2nc(S(=O)(=O)Nc3c(F)cccc3F)nn12]

Its herbicidal activity is described in The Pesticide Manual. Exemplary uses of florasulam includes, but are not limited to, post-emergence control of broadleaf weeds in cereals and maize.

Flumetsulam, shown below, is N-(2,6-difluorophenyl)-5-methyl[1,2,4]triazolo[1,5-c]pyrimidine-2-sulfonamide.

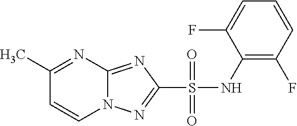 [SMILES: Cc1ccn2nc(S(=O)(=O)Nc3c(F)cccc3F)nc2n1]

Its herbicidal activity is described in The Pesticide Manual. Exemplary uses of flumetsulam include, but are not limited to, control of broadleaf weeds and grasses in soybeans, field peas and maize.

Metosulam, shown below, is N-(2,6-dichloro-3-methylphenyl)-5,7-dimethoxy[1,2,4]triazolo[1,5-a]pyrimidine-2-sulfonamide

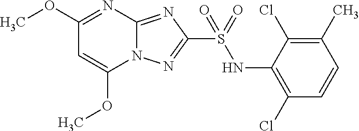

Its herbicidal activity is described in The Pesticide Manual. Exemplary uses of metosulam includes, but are not limited to, post-emergence control of broadleaf weeds in wheat, barley and rye, and pre- or post-emergence control of broadleaf weeds in maize.

Penoxsulam, shown below, is 2-(2,2-difluoroethoxy)-N-(5,8-dimethoxy[1,2,4]triazolo[1,5-c]pyrimidin-2-yl)-6-(trifluoromethyl)benzenesulfonamide

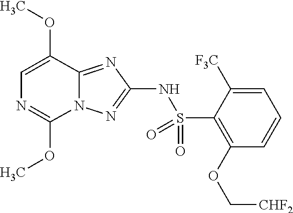 [SMILES: COc1cnc(OC)n2nc(NS(=O)(=O)c3c(OCC(F)F)cccc3C(F)(F)F)nc12]

Its herbicidal activity is described in The Pesticide Manual. Exemplary uses of penoxsulam includes, but are not limited to, post-emergence control of Echinochloa spp., broadleaf weeds and annual sedge weeds in rice, as well as Echinochloa spp. and broadleaf weeds in sorghum, turf, cereals and tree and vine crops. In another example, penoxsulam is used to control aquatic weeds in lakes and ponds.

Pyroxsulam, shown below, is N-(5,7-dimethoxy[1,2,4]triazolo[1,5-a]pyrimidin-2-yl)-2-methoxy-4-(trifluoromethyl)-3-pyridinesulfonamide.

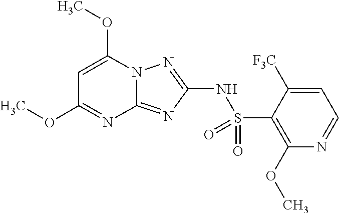 [SMILES: COc1cc(OC)n2nc(NS(=O)(=O)c3c(C(F)(F)F)ccnc3OC)nc2n1]

Its herbicidal activity is described in The Pesticide Manual. Exemplary uses of pyroxsulam include, but are not limited to, broad spectrum post-emergence control of annual grass and broadleaf weeds in cereals.

C. Glyphosate

Glyphosate, (N-(phosphonomethyl)glycine), is a broad-spectrum systemic herbicide used to kill weeds, especially annual broadleaf weeds and grasses known to compete with commercial crops. Glyphosate, shown below,

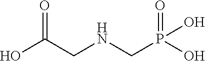

is an aminophosphonic analogue of the natural amino acid glycine. Glyphosate's mode of action is to inhibit a plant enzyme involved in the synthesis of the aromatic amino acids tyrosine, tryptophan, and phenylalanine. It is absorbed through foliage, and minimally through roots and translocated to growing points. Because of this mode of action, it is only effective on actively growing plants; it is not effective as a pre-emergence herbicide. Glyphosate can be used as the free acid or an agriculturally acceptable salt or ester thereof. Salts include inorganic salts produced by the addition of an inorganic base. Such salts include sodium and potassium salts. Other salts include those salts prepared by the addition of an organic base such as a primary, secondary, or tertiary amine, such as those listed above. Specific examples include dimethylamine, isopropyl amine, and ethanolamine

Glyphosate is sold commercially under a variety of trade names including Abundit Extra (DuPont Crop Protection); Abundit Extra (Nufarm Americas Inc.); Acigate (Agro Chemicals Industries Ltd. (ACI)); Agrofosate (AgroDragon Co., Ltd.); Algood (Kuang Hwa Chemical Co., Ltd.); Amiphosate (Agrolex Pte. Ltd.); Ammo (Ancom Crop Care S.B.); Aqua Star (Albaugh, Inc.); Aquamaster (Monsanto Co.); AquaNeat (Nufarm Americas Inc.); AquaPro (SePRO Corp.); Arbex (Dupocsa, Protectores Quimicos para el Campo S.A.); Arbex (Crystal Chemical Inter-America); Arimo (Makhteshim Agan Group); ARRASADOR (Nanjing Agrochemical Co., Ltd.); ARRASADOR SUPER (Nanjing Agrochemical Co., Ltd.); Asset (Ancom Crop Care S.B.); Atred (Dupocsa, Protectores Quimicos para el Campo S.A.); Audit (PT. Mastec); Backdraft (BASF Corporation); Banox (Crystal Chemical Inter-America); Banox (Dupocsa, Protectores Quimicos para el Campo S.A.); Bingo (Stockton (Israel) Ltd.); Bounce (Zagro Singapore Pte. Ltd.); Bounty (Meridian Agrochemical Pty. Ltd. t/a Meridian Agritech); Break Up (Plant Remedies Pvt. Ltd.); BROUT (AAKO B.V.); Butazin (Makhteshim Agan Group); Callisto GT (Syngenta); Chief (Makhteshim Agan Group); Cinco (Loveland Products, Inc.); Clean-Up (Indofil Industries Limited); Clipper (Insecticidas Internacionales, C.A.); Coctel (Lainco, S.A.); Coloso (Syngenta); Control (Premier.Shukuroglou Cyprus Ltd.); Cornerstone (WinField Solutions, LLC); Cornerstone Plus (WinField Solutions, LLC); CoStarr (Albaugh, Inc.); Cottonex PG (Makhteshim Agan Group); Credit (Nufarm Americas Inc.); Credit Duo (Nufarm Americas Inc.); Credit Duo Extra (Nufarm Americas Inc.); Credit Extra (Nufarm Americas Inc.); Credit Master (Nufarm Americas Inc.); Credit Xtreme (Nufarm Americas Inc.); Crunch (Zagro Singapore Pte. Ltd.); Cycle (Syngenta); De-Phosate (Drexel Chemical Co.); Departure (Syngenta); Dera (Dhanuka Agritech Ltd.); Desafio (Velsimex SA de CV); Dhruv (M/S HPM Chemicals and Fertilizers Ltd.); Dominator (Dow AgroSciences LLC); Duramax (Dow AgroSciences LLC); Durango (Dow AgroSciences LLC); Durango DMA (Dow AgroSciences LLC); Eagrow (Shandong Kesai Eagrow Co., Ltd.); Epostar (Agri Sciences Co., Ltd.); Eraser (Makhteshim Agan Group); Estelar (Dow AgroSciences LLC); Excel DF Gold (Excel Crop Care Limited); Excel Mera 71 (Excel Crop Care Limited); Expert (Syngenta); Extra Credit 5 (Nufarm Americas Inc.); Extreme (BASF Corporation); Extril (Eastsun Chemical Co., Ltd.); EZ-Ject Diamondback (EZ-Ject, Inc.); Faena (Proficol); Faiter (Insecticidas Internacionales, C.A.); Fallow Star (Albaugh, Inc.); Fertiphosate (Fertiagro Pte. Ltd.); FirstStep Complete (Loveland Products Canada Inc.); Flexstar GT (Syngenta); Focus (Monsanto Co.); Forest Star (Albaugh, Inc.); Foresters (Nufarm Americas Inc.); Forwasate (Forward International Ltd.); Four Power Plus (Loveland Products, Inc.); Fozat (Agro-Chemie Ltd.); Galaxia (Agrimix s r 1); Galaxy (Makhteshim Agan Group); Galigan Slapshot (Makhteshim Agan Group); Garud (M/S HPM Chemicals and Fertilizers Ltd.); Gladiator (Devidayal Sales Limited); Glam (Sabero Organics Gujarat Limited); Gland-Up (VAPCO, Veterinary & Agricultural Products Mfg. Co. Ltd.); Glidder (M/S Modern Insecticides Ltd.); Glifazin (Makhteshim Agan Group); Glifene (Diachem S.p.A.); Glifonox* (Crystal Chemical Inter-America); Glifonox* (Dupocsa, Protectores Quimicos para el Campo S.A.); Glifonox* M (Dupocsa, Protectores Quimicos para el Campo S.A.); Glifosato* (Willowood Ltd.); Glifosato* (Stockton (Israel) Ltd.); Glifotox* (Pyosa, S.A. de C.V.); Glifuron* (Dupocsa, Protectores Quimicos para el Campo S.A.); Glisompa* (Probelte S.A.); Gliz* (Dow AgroSciences LLC); Globus* (Nagarjuna Agrichem Ltd.); Gly Star* (Albaugh, Inc.); Glycel* (Excel Crop Care Limited); Glycel Super* (Excel Crop Care Limited); Glycides* (Sree Ramcides Chemicals Pvt. Ltd.); Glycor* (Coromandel International Limited); Glydus* Primo (Makhteshim Agan Group); Glyfall* (Sundat (S) Pte. Ltd.); Glyfomon* (Agro-Care Chemical Industry Group Limited); Glyfon Up* (Sharabati Bro Trading & Agricultural Co.); Glyfos* (Cheminova A/S); Glyfos* (Cheminova, Inc.); Glyfos* Aquatic (Cheminova, Inc.); Glyfos* PRO (Cheminova, Inc.); Glyfos* X-Tra (Cheminova, Inc.); Glyfosan* (Insecticidas Internacionales, C.A.); Glygran* (Villa Crop Protection); GlyKamba* (Nufarm Americas Inc.); GlyPho Sel Pro* (Agrisel USA Inc.); Glypho Up* (Willowood Ltd.); Glyphocare* (Agro-Care Chemical Industry Group Limited); Glyphogan* (Proficol); Glyphogan* (Makhteshim Agan Group); Glyphogan* Plus (Makhteshim Agan Group); GlyphoMate* 41 (PBI/Gordon Corp.); Glyphomax* (Dow AgroSciences LLC); Glyphomax* Plus (Dow AgroSciences LLC); Glyphomax* XRT (Dow AgroSciences LLC); Glyphostock* (Stockton (Israel) Ltd.); Glyphotox* (Aimco Pesticides Limited); Glypro* (Dow AgroSciences LLC); Glypro* Plus (Dow AgroSciences LLC); Glytaf* (Rallis India Ltd.); Glytex* (VAPCO, Veterinary & Agricultural Products Mfg. Co. Ltd.); Gly-Tox* (Indiclay); Glyweed* (Sabero Organics Gujarat Limited); Glyxtra* (Agroquimicos Versa, S.A. de C.V.); Grand Sweeper* (AgroDragon Co., Ltd.); Grenade* (ISAGRO (Asia) Agrochemicals Pvt. Ltd.); Ground-Up* (VAPCO, Veterinary & Agricultural Products Mfg. Co. Ltd.); Halex* GT (Syngenta); Hat-trick* (Ancom Crop Care S.B.); Helosate* Plus Advanced (Helm Agro US, Inc.); Herbanil* (AGROLOGY S.A.); Herb-neat* (Forward International Ltd.); Herbolex* (Aragonesas Agro, S.A.); Herphosate* (National Company for Agrochemicals Production (Agrochem)); Hexagor* (Coromandel International Limited); Hiljack* (Insecticides (India) Limited); Honcho* Plus (Monsanto Co.); Imitator Aquatic* (Drexel Chemical Co.); Imitator PA Plus* (Drexel Chemical Co.); Imitator Plus* (Drexel Chemical Co.); Imitator RTU* (Drexel Chemical Co.); Index* (PT. Mastec); Inter rescuer* (Jiangsu Inter-China Group Corporation); Jinfanda* (Zhejiang Jinfanda Biochemical Co., Ltd.); Journey* (BASF Corporation); Karda* (Lainco, S.A.); Killshot* (Coromandel International Limited); KleenUp Pro* (Loveland Products, Inc.); KleenUp Pro* (United Agri Products (UAP)); Knockdown* (SAFA TARIM A.S.); Knockdown Max* (SAFA TARIM A.S.); Knock-Out* (Hektas Ticaret T.A.S.); Korfosat* (Koruma Tarim A.S.); Krup* (Krishi Rasayan Exports Pvt. Ltd.); LA FAM* (Agricultura Nacional SA de CV); Landmaster* BW (Albaugh, Inc.); Landmaster* II (Monsanto Co.); LEPRINCE* (AAKO B.V.); Longyou* (Jingma Chemicals Ltd.); Mad Dog* (Loveland Products, Inc.); Mad Dog Plus* (Loveland Products, Inc.); Makaze* (Loveland Products, Inc.); Makaze* (United Agri Products (UAP)); Makaze Yield Pro* (Loveland Products, Inc.); Master* (PT. Mastec); Mirage* (Loveland Products, Inc.); Mirage* Plus (Loveland Products, Inc.); Mocan* 943 (Monsanto Co.); Noweed* (Dhanuka Agritech Ltd.); OneStep* (BASF Corporation); OVNI* (AAKO B.V.); Panga* (Villa Crop Protection); Panga* Plus (Villa Crop Protection); Panga* Turbo (Villa Crop Protection); Panzer* (Dow AgroSciences LLC); Panzer* (Invesa S.A.); Partner* (PT. Mastec); Phomac* (Medmac for Manufacturing Agricultural Chemicals & Veterinary Products Ltd.); PI Glypho* (PI Industries Ltd.); Pilarsato* (PilarBio(CANADA) Corp.); Pin Up* (Agsin Pte. Ltd.); Pin Up* (Zagro Singapore Pte. Ltd.); Police* (Aragonesas Agro, S.A.); Potensato* (Stockton (Israel) Ltd.); Pounce* (Zagro Singapore Pte. Ltd.); Pounce* (Agsin Pte. Ltd.); Prep-It* (Loveland Products, Inc.); Prince Gold* (Stockton (Israel) Ltd.); ProDeuce* (Nufarm Americas Inc.); Pronto* (PBI/Gordon Corp.); Punch* (Zagro Singapore Pte. Ltd.); Ranger PRO* (Monsanto Co.); Rattler* (Helena Chemical Co.); Razor* (Nufarm Americas Inc.); Razor Burn* (Nufarm Americas Inc.); Razor* Pro (Nufarm Americas Inc.); Recoil* (Nufarm Americas Inc.); Refuge* (Syngenta); Reuters* (PT. Mastec); Ricochet* (Makhteshim Agan Group); Rinder* (Inquiport, S.A.); Rondo* (United Phosphorus Ltd.); Rondo* (Dupocsa, Protectores Quimicos para el Campo S.A.); Rondo Logico* (United Phosphorus Ltd.); Rondo Super* (United Phosphorus Ltd.); Rondomor* (Efal-Agri); Rondomor* (Stockton (Israel) Ltd.); Rophosate* (Rotam CropScience Ltd.); Roundap* (Ranjit Insecticides Pvt. Ltd.); Roundup* Fastforward (Monsanto Co.); Roundup PowerMAX* (Monsanto Co.); Roundup ProMAX* (Monsanto Co.); Roundup QuikPRO* (Monsanto Co.); Roundup* Ultra (Monsanto Co.); Roundup WeatherMAX* (Monsanto Co.); RT 3* (Monsanto Co.); Rudo* (Agroquimicos Versa, S.A. de C.V.); Samba* (Makhteshim Agan Group); Sanos* (Hubei Sanonda Co., Ltd.); Seccherba* (Agrimix s r 1); Sequence* (Syngenta); Shore-Klear* (Applied Biochemists); Shoreklear*-Plus (Applied Biochemists); Sickle* (Sanonda (Australia) Pty. Ltd.); Sigma Max* (Stockton (Israel) Ltd.); Slash* (Zagro Singapore Pte. Ltd.); Smart* (PT. Mastec); Special* (PT. Mastec); Speed* (Excel Crop Care Limited); Stand-up* (Meerut Agro Chemical Industries Ltd.); StartUp* (Loveland Products Canada Inc.); Stockton* Glyphosate (Stockton (Israel) Ltd.); Stopper* (Polsas Chemicals and Machinery Co.); Sunup* (Sundat (S) Pte. Ltd.); Supex* (Crystal Chemical Inter-America); Supex* (Dupocsa, Protectores Quimicos para el Campo S.A.); Supremo* (Hextar Chemicals Sdn Bhd); Sweep* (United Phosphorus Ltd.); Swift* (Sundat (S) Pte. Ltd.); TagG2* (Zelam Ltd.); Taifun* Forte (Makhteshim Agan Group); Tecoglif* (Tecomag S.r.1.); Terminator* (Willowood Ltd.); Thunder Master* (Albaugh, Inc.); Tomcato* (Probelte S.A.); Topanex* (Aragonesas Agro, S.A.); Torment* (Willowood Ltd.); Total* (Chemiplant S.A.); Touchdown* CT (Syngenta); Touchdown* CT2 (Syngenta); Touchdown* HiTech (Syngenta); Touchdown* PRO (Syngenta); Touchdown* Total (Syngenta); Tragli* (TRAGUSA (Tratamientos Guadalquivir S.L.)); Traxion* (Syngenta); Trinnashi* (Hindustan Insecticides Ltd.); Trop* (Milenia Agrociencias S.A.); Updow* (Ladda Co., Ltd.); Valsaglif* (Stockton (Israel) Ltd.); Valsaup* (Stockton (Israel) Ltd.); Vantage* Plus (Dow AgroSciences LLC); Velfosato* (Velsimex SA de CV); Vifosat* (Vietnam Pesticide Joint Stock Co. (VIPESCO)); Viking* (Ivorychem Pte. Ltd.); Vinash* (Sulphur Mills Limited); Viterra* Glyphosate (Loveland Products Canada Inc.); Weedclear* (Willowood Ltd.); Weedex* (Acme Organics Pvt. Ltd.); Willosate* (Willowood Ltd.); Wipe Out* (Zagro Singapore Pte. Ltd.); Wipe Out* (Agsin Pte. Ltd.); Woproglyph* (Simonis BV); Yerbimat* (Ingenieria Industrial, S.A. de C.V. (Bravo Ag)); and Zoomer* (Makhteshim Agan Group).

### III. Tank Mixes, PreMixes and Co-Packs

Tank mixes, premixes and co-packs containing the compound of formula (I) or a salt or ester thereof, a triazolopyrimidine sulfonamide herbicide or a salt or ester thereof, and glyphosate or a salt or ester thereof are described herein. In some embodiments, the tank mix is prepared by mixing a premix of the compound of formula (I) or a salt or ester there of and a triazolopyrimidine sulfonamide herbicide or a salt or ester thereof with a concentrate containing glyphosate or a salt or ester thereof. In some embodiments, (b) includes, but is not limited to, cloransulam, diclosulam, florasulam, flumetsulam, metosulam, penoxsulam, or pyroxsulam, agriculturally acceptable salts or esters thereof, or combinations thereof. In other embodiments, the tank mix is prepared by mixing the compound of formula (I) or a salt or ester thereof and glyphosate or a salt or ester thereof with a triazolopyrimidine sulfonamide herbicide or a salt or ester thereof. In still other embodiments, the premix or co-pack contains all three active ingredients which is diluted prior to use/application. The premix or suitable premixes can contain one or more suitable adjuvants and/or carriers.

In some embodiments, compositions provided herein contain at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with herbicidal components or other composition ingredients. Such mixtures can be designed for application directly to weeds or their locus or can be concentrates or formulations that are normally diluted with additional carriers and adjuvants before application. They can be solids, such as, for example, dusts, granules, water-dispersible granules, or wettable powders, or liquids, such as, for example, emulsifiable concentrates, solutions, emulsions or suspensions. They can also be provided as a premix or tank-mixed.

Suitable agricultural adjuvants and carriers include, but are not limited to, crop oil concentrate; nonylphenol ethoxylate; benzylcocoalkyldimethyl quaternary ammonium salt; blend of petroleum hydrocarbon, alkyl esters, organic acid, and anionic surfactant; C₉-C₁₁ alkylpolyglycoside; phosphated alcohol ethoxylate; natural primary alcohol (C₁₂-C₁₆) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG(400) dioleate-99.

Liquid carriers that can be employed include water and organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Specific organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. In certain embodiments, water is the carrier for the dilution of concentrates.

Suitable solid carriers include but are not limited to talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, cellulose, and the like.

In some embodiments, the compositions described herein further comprise one or more surface-active agents. In some embodiments, such surface-active agents are employed in both solid and liquid compositions, and in certain embodiments those designed to be diluted with carrier before application. The surface-active agents can be anionic, cationic or nonionic in character and can be employed as emulsifying agents, wetting agents, suspending agents, or for other purposes. Surfactants which may also be used in the present formulations are described, inter alia, in McCutcheon's Detergents and Emulsifiers Annual, MC Publishing Corporation: Ridgewood, N.J., 1998 and in Encyclopedia of Surfactants, Vol. 1-111, Chemical Publishing Company: New York, 1980-81. Surface-active agents include, but are not limited to salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C18 ethoxylate; alcohol-alkylene oxide addition products, such as tridecyl alcohol-C16 ethoxylate; soaps, such as sodium stearate; alkyl-naphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

In some embodiments, these materials, such as vegetable or seed oils and their esters, can be used interchangeably as an agricultural adjuvant, as a liquid carrier or as a surface active agent.

Other exemplary additives for use in the compositions provided herein include but are not limited to compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

The tank mixes described herein can further contain one or more additional herbicides. The herbicides can be incorporated into the one or more of the premixes, tank mixes or concentrates or can be added at the time the tank mix is prepared by formulation or prior to application. When used in conjunction with other herbicides, the composition can be formulated with the other herbicide or herbicides, tank-mixed with the other herbicide or herbicides or applied sequentially with the other herbicide or herbicides. Some of the herbicides that can be employed in conjunction with the compositions and methods described herein include, but are not limited to: 4-CPA, 4-CPB, 4-CPP, 2,4-D, 2,4-D choline salt, 2,4-D esters and amines, 2,4-DB, 3,4-DA, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron-methyl, bensulide, benthiocarb, bentazon-sodium, benzadox, benzfendizone, benzipram, benzobicyclon, benzofenap, benzofluor, benzoylprop, benzthiazuron, bicyclopyrone, bifenox, bilanafos, bispyribac-sodium, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clacyfos, clethodim, cliodinate, clodinafop-propargyl, clofop, clomazone, clomeprop, cloprop, cloproxydim, clopyralid, CMA, copper sulfate, CPMF, CPPC, credazine, cresol, cumyluron, cyanatryn, cyanazine, cycloate, cyclopyrimorate, cyclosulfamuron, cycloxydim, cycluron, cyhalofop-butyl, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop-methyl, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethbenzamide, ethametsulfuron, ethidimuron, ethiolate, ethobenzanid, ethofumesate, ethoxyfen, ethoxysulfuron, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenquinotrione, fenteracol, fenthiaprop, fentrazamide, fenuron, ferrous sulfate, flamprop, flamprop-M, flazasulfuron, florpyrauxifen, fluazifop, fluazifop-P-butyl, fluazolate, flucarbazone, flucetosulfuron, fluchloralin, flufenacet, flufenican, flufenpyr-ethyl, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, fluroxypyr, flurtamone, fluthiacet, fomesafen, foramsulfuron, fosamine, fumiclorac, furyloxyfen, glufosinate, glufosinate-ammonium, glufosinate-P-ammonium, halosafen, halosulfuron-methyl, haloxydine, haloxyfop-methyl, haloxyfop-P-methyl, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, iodosulfuron-ethyl-sodium, iofensulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lancotrione, lenacil, linuron, MAA, MAMA, MCPA esters and amines, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metoxuron, metribuzin, metsulfuron, metsulfuron-methyl, molinate, monalide, monisouron, monochloroacetic acid, monolinuron, monuron, morfamquat, MSMA, naproanilide, napropamide, napropamide-M, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, paraflufen-ethyl, parafluron, paraquat, pebulate, pelargonic acid, pendimethalin, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron-methyl, procyazine, prodiamine, profluazol, profluralin, profoxydim, proglinazine, prohexadione-calcium, prometon, prometryn, pronamide, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen-ethyl, pyrasulfotole, pyrazogyl, pyrazolynate, pyrazosulfuron-ethyl, pyrazoxyfen, pyribenzoxim, pyributicarb, pyriclor, pyridafol, pyridate, pyriftalid, pyriminobac, pyrimisulfan, pyrithiobac-sodium, pyroxasulfone, quinclorac, quinmerac, quinoclamine, quinonamid, quizalofop, quizalofop-P-ethyl, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosate, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thifensulfuron-methyl, thiobencarb, tiafenacil, tiocarbazil, tioclorim, tolpyralate, topramezone, tralkoxydim, triafamone, tri-allate, triasulfuron, triaziflam, tribenuron, tribenuron-methyl, tricamba, triclopyr choline salt, triclopyr esters and salts, tridiphane, trietazine, trifloxysulfuron, trifludimoxazin, trifluralin, triflusulfuron, trifop, trifopsime, trihydroxytriazine, trimeturon, tripropindan, tritac, tritosulfuron, vernolate, xylachlor and salts, choline salts, esters, optically active isomers and mixtures thereof.

In some embodiments, the compositions described herein are employed in combination with one or more herbicide safeners, such as AD-67 (MON 4660), benoxacor, benthiocarb, brassinolide, cloquintocet (mexyl), cyometrinil, cyprosulfamide, daimuron, dichlormid, dicyclonon, dimepiperate, disulfoton, fenchlorazole-ethyl, fenclorim, flurazole, fluxofenim, furilazole, harpin proteins, isoxadifen-ethyl, jiecaowan, jiecaoxi, mefenpyr-diethyl, mephenate, naphthalic anhydride (NA), oxabetrinil, R29148, and N-phenyl-sulfonylbenzoic acid amides, to enhance their selectivity. In some embodiments, the safeners are employed in soybean, cotton, sunflower, rice, canola, oilseed rape, cereals (including but not limited to wheat, barley, oats and rye), sorghum, corn or maize settings.

In some embodiments, the compositions and methods described herein can be used in combination with one or more seed treatments known to be employed in the safening of rice and compounds of formula (I), including naphthalic anhydride and CAS registry number 129531-12-0 (N-(2-methoxybenzoyl)-4-[(methylaminocarbonyl)amino]benzenesulfonamide), which has the following structure,

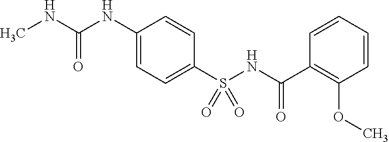

and CAS registry number 98967-94-3 (methyl 3-((5,7-dimethyl-[1,2,4]triazolo[1,5-a]pyrimidine)-2-sulfonamido)thiophene-2-carboxylate), which has the following structure,

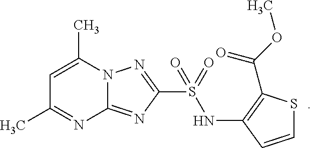 [SMILES: COC(=O)c1sccc1NS(=O)(=O)c1nc2nc(C)cc(C)n2n1]

In some embodiments, the safener is cloquintocet or an ester or salt thereof. In certain embodiments, cloquintocet is utilized to antagonize harmful effects of the compositions on rice and cereals. In some embodiments, the safener is cloquintocet (mexyl).

In some embodiments the methods provided herein are used to control undesirable vegetation in crops that are tolerant to glyphosate, glufosinate, dicamba, phenoxy auxins, pyridyloxy auxins, aryloxyphenoxypropionates, acetyl CoA carboxylase (ACCase) inhibitors, imidazolinones, acetolactate synthase (ALS) inhibitors, 4-hydroxyphenyl-pyruvate dioxygenase (HPPD) inhibitors, protoporphyrinogen oxidase (PPO) inhibitors, triazines, or bromoxynil. Such herbicide tolerant crops may possesses multiple or stacked traits conferring tolerance to multiple herbicides or multiple modes of action.

In some embodiments the methods provided herein are used to control undesirable vegetation that is a herbicide resistant or tolerant weed. Such herbicide resistant or tolerant weed may have a biotype with resistance or tolerance to single or multiple herbicides, single or multiple chemical classes, or single or multiple herbicide modes of action. For example, the herbicide resistant or tolerant weed may have a biotype resistant or tolerant to acetolactate synthase (ALS) inhibitors, photosystem II inhibitors, acetyl CoA carboxylase (ACCase) inhibitors, synthetic auxins, phenoxy auxins, pyridyloxy auxins, photosystem I inhibitors, 5-enolpyruvylshikimate-3-phosphate (EPSP) synthase inhibitors, microtubule assembly inhibitors, lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes of action, quinclorac, arylaminopropionic acids, difenzoquat, endothall, or organoarsenicals.

In some embodiments, the concentration of the active ingredients in the compositions described herein is from about 0.0005 to 98 percent by weight. In some embodiments, the concentration is from about 0.0006 to 90 percent by weight. In compositions designed to be employed as concentrates, the active ingredients, in certain embodiments, are present in a concentration from about 0.1 to 98 weight percent, and in certain embodiments about 0.5 to 90 weight percent. Such compositions are, in certain embodiments, diluted with an inert carrier, such as water, before application. The diluted compositions usually applied to weeds or the locus of weeds contain, in certain embodiments, about 0.0003 to 10.0 weight percent active ingredient and in certain embodiments contain about 0.0008 to 5.0 weight percent.

### IV. Methods of Use

Herbicidal activity (control of undesirable vegetation in a crop or non-crop situation) is exhibited by the herbicidal compositions when they are applied directly to the plant or to the locus of the plant at any stage of growth, or to the area where control of vegetation is desired. The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted to promote non-selective or selective herbicidal action. In some embodiments, the compositions described herein are applied as a post-emergence application to the crop and undesirable vegetation, pre-emergence application to the crop and post-emergence to the undesirable vegetation, and as multiple post-emergence applications to relatively immature undesirable vegetation to achieve the maximum control of weeds.

In some embodiments, the compositions and methods provided herein are utilized to control weeds in crops, including but not limited to soybean, cotton, sunflower, winter/spring oilseed rape, winter/spring canola, vegetables, ornamentals, rice, wheat, teff, triticale, barley, oats, rye, sorghum, corn/maize, sunflower, row crops, pastures, grasslands, rangelands, fallowland, fallow bed, sugarcane, turf, tree and vine orchards, aquatics, forestry, industrial vegetation management (IVM) and rights-of-way. In some embodiments, the compositions are used in the burndown and control of weeds in fallow fields and fallow beds between the planting of crops, such as soybean, corn, cotton, sunflower, cereals, rice, winter/spring oilseed rape, winter/spring canola, corn/maize and sorghum. In other embodiments, the compositions are used to control weeds just prior to or after planting soybeans.

The compositions and methods provided herein are utilized to control undesirable vegetation. Undesirable vegetation includes, but is not limited to, undesirable vegetation that occurs in soybean, cotton, oilseed rape, peanuts, canola, vegetables, ornamentals, rice, wheat, teff, triticale, barley, oats, rye, sorghum, corn/maize, winter/spring oilseed rape, winter/spring canola, sunflower, row crops, pastures, grasslands, rangelands, fallowland, fallow bed, sugarcane, turf, tree and vine orchards, forestry, IVM and rights-of-way.

In some embodiments, the methods provided herein are utilized to control undesirable vegetation in fallow fields and fallow beds between crops, before planting soybean, cotton, corn/maize, sunflower, rice, oilseed rape, canola, drilled crops and cereal crops, and after planting tolerant crops such as soybeans and other row crops. In certain embodiments, the undesirable vegetation is Alopecurus myosuroides Huds. (blackgrass, ALOMY), Apera spicaventi (L.) Beauv. (windgrass, APESV), Avena fatua (wild oat, AVEFA), Bromus tectorum L. (downy brome, BROTE), Lolium multiflorum Lam. (Italian ryegrass, LOLMU), Lolium rigidum (rigid ryegrass, LOLRI), Lolium multiflorum subsp. Gaudini (annual ryegrass, LOLMG), Phalaris minor Retz. (littleseed canarygrass, PHAMI), Poa annua (annual bluegrass, POAAN), Setaria pumila (Poir.) Roemer & J. A. Schultes (yellow foxtail, SETLU), Setaria viridis (L.) Beauv. (green foxtail, SETVI), Cirsium arvense (L.) Scop. (Canada thistle, CIRAR), Commelina benghalensis (tropical spiderwort, COMBE), Conyza canadensis (horseweed/marestail, ERICA), Conyza bonariensis (fleabane, ERIBO), Echinochloa crus-galli (L.) P. Beauv. (barnyardgrass, ECHCG), Euphorbia heterophylla L. (wild poinsettia, EPHHL), Conyza sumatrensis (Guernsey fleabane, ERISU), Ipomoea grandifolia (Corda-de-viola, IAQGR), Galium aparine (catchweed bedstraw, GALAP), Kochia scoparia (L.) Schrad. (kochia, KCHSC), Lamium purpureum (purple deadnettle, LAMPU), Matricaria recutita (wild chamomile, MATCH), Matricaria matricarioides (Less.) Porter (pineappleweed, MATMT), Papaver rhoeas (common poppy, PAPRH), Polygonum convolvulus (wild buckwheat, POLCO), Salsola tragus (Russian thistle, SASKR), Stellaria media (L.) Vill. (common chickweed, STEME), Veronica persica Poir. (Persian speedwell, VERPE), Viola arvensis Murr. (field violet, VIOAR), or Viola tricolor L. (wild violet, VIOTR).

In some embodiments, the compositions and methods provided herein are utilized to control undesirable vegetation in fallow fields and fallow beds between crops or before planting in rice. In certain embodiments, the undesirable vegetation is Brachiaria platyphylla (Groseb.) Nash (broadleaf signalgrass, BRAPP), Digitaria sanguinalis (L.) Scop. (large crabgrass, DIGSA), Echinochloa crus-galli (L.) P. Beauv. (barnyardgrass, ECHCG), Echinochloa colonum (L.) LINK (junglerice, ECHCO), Echinochloa oryzoides (Ard.) Fritsch (early watergrass, ECHOR), Echinochloa oryzicola (Vasinger) Vasinger (late watergrass, ECHPH), Conyza canadensis (horseweed/marestail, ERICA), Ischaemum rugosum Salisb. (saramollagrass, ISCRU), Leptochloa chinensis (L.) Nees (Chinese sprangletop, LEFCH), Leptochloa fascicularis (Lam)) Gray (bearded sprangletop, LEFFA), Leptochloa panicoides (Presl.) Hitchc. (Amazon sprangletop, LEFPA), Panicum dichotomiflorum (L.) Michx. (Fall panicum, PANDI), Paspalum dilatatum Poir. (dallisgrass, PASDI), Cyperus difformis L. (smallflower flatsedge, CYPDI), Cyperus esculentus L. (yellow nutsedge, CYPES), Cyperus iria L. (rice flatsedge, CYPIR), Cyperus rotundus L. (purple nutsedge, CYPRO), Eleocharis species (ELOSS), Fimbristylis miliacea (L.) Vahl (globe fringerush, FIMMI), Schoenoplectus juncoides Roxb. (Japanese bulrush, SPCJU), Schoenoplectus maritimus L. (sea clubrush, SCPMA), Schoenoplectus mucronatus L. (ricefield bulrush, SCPMU), Aeschynomene species, (jointvetch, AESSS), Alternanthera philoxeroides (Mart.) Griseb. (alligatorweed, ALRPH), Alisma plantago-aquatica L. (common waterplantain, ALSPA), Amaranthus species, (pigweeds and amaranths, AMASS), Ammannia coccinea Rottb. (redstem, AMMCO), Eclipta alba (L.) Hassk. (American false daisy, ECLAL), Heteranthera limosa (SW.) Willd./Vahl (ducksalad, HETLI), Heteranthera reniformis R. & P. (roundleaf mudplantain, HETRE), Ipomoea hederacea (L.) Jacq. (ivyleaf morningglory, IPOHE), Lindernia dubia (L.) Pennell (low false pimpernel, LIDDU), Monochoria korsakowii Regel & Maack (monochoria, MOOKA), Monochoria vaginalis (Burm. F.) C. Presl ex Kuhth, (monochoria, MOOVA), Murdannia nudiflora (L.) Brenan (doveweed, MUDNU), Polygonum pensylvanicum L., (Pennsylvania smartweed, POLPY), Polygonum persicaria L. (ladysthumb, POLPE), Polygonum hydropiperoides Michx. (mild smartweed, POLHP), Rotala indica (Willd.) Koehne (Indian toothcup, ROTIN), Sagittaria species, (arrowhead, SAGSS), Sesbania exaltata (Raf.) Cory/Rydb. Ex Hill (hemp sesbania, SEBEX), or Sphenoclea zeylanica Gaertn. (gooseweed, SPDZE).

In some embodiments, the compositions and methods provided herein are utilized to control undesirable vegetation in fallow fields and fallow beds between crops or before planting range and pasture and forestry. In certain embodiments, the undesirable vegetation is Ambrosia artemisiifolia L. (common ragweed, AMBEL), Cassia obtusifolia (sickle pod, CASOB), Centaurea maculosa auct. non Lam (spotted knapweed, CENMA), Cirsium arvense (L.) Scop. (Canada thistle, CIRAR), Commelina benghalensis L. (tropical spiderwort, COMBE), Conyza canadensis (horseweed/marestail, ERICA), Conyza bonariensis (fleabane, ERIBO), Echinochloa crus-galli (L.) P. Beauv. (barnyardgrass, ECHCG), Euphorbia heterophylla L. (wild poinsettia, EPHHL), Conyza canadensis (horseweed/marestail, ERICA), Conyza bonariensis (fleabane, ERIB0), Conyza sumatrensis (Guernsey fleabane, ERISU), Ipomoea grandifolia (Corda-de-viola, IAQGR), Convolvulus arvensis L. (field bindweed, CONAR), Euphorbia esula L. (leafy spurge, EPHES), Lactuca serriola L./Torn. (prickly lettuce, LACSE), Plantago lanceolata L. (buckhorn plantain, PLALA), Rumex obtusifolius L. (broadleaf dock, RUMOB), Sida spinosa L. (prickly sida, SIDSP), Sinapis arvensis L. (wild mustard, SINAR), Sonchus arvensis L. (perennial sowthistle, SONAR), Solidago species (goldenrod, SOOSS), Taraxacum officinale G.H. Weber ex Wiggers (dandelion, TAROF), Trifolium repens L. (white clover, TRFRE), or Urtica dioica L. (common nettle, URTDI).

In some embodiments, the compositions and methods provided herein are utilized to control undesirable vegetation in fallow fields and fallow beds between crops, before planting crops, or within row crops and vegetable crops. In certain embodiments, the undesirable vegetation is Alopecurus myosuroides Huds. (blackgrass, ALOMY), Avena fatua L. (wild oat, AVEFA), Brachiaria platyphylla (Groseb.) Nash (broadleaf signalgrass, BRAPP), Commelina benghalensis L. (tropical spiderwort, COMBE), Conyza sumatrensis (Guernsey fleabane, ERISU), Ipomoea grandifolia (Corda-de-viola, IAQGR), Digitaria sanguinalis (L.) Scop. (large crabgrass, DIGSA), Echinochloa crus-galli (L.) P. Beauv. (barnyardgrass, ECHCG), Echinochloa colonum (L.) Link (junglerice, ECHCO), Lolium multiflorum Lam. (Italian ryegrass, LOLMU), Panicum dichotomiflorum Michx. (Fall panicum, PANDI), Panicum miliaceum L. (wild-proso millet, PANMI), Setaria faberi Herrm. (giant foxtail, SETFA), Setaria viridis (L.) Beauv. (green foxtail, SETVI), Sorghum halepense (L.) Pers. (Johnsongrass, SORHA), Sorghum bicolor (L.) Moench ssp. Arundinaceum (shattercane, SORVU), Cyperus esculentus L. (yellow nutsedge, CYPES), Cyperus rotundus L. (purple nutsedge, CYPRO), Abutilon theophrasti Medik. (velvetleaf, ABUTH), Amaranthus species (pigweeds and amaranths, AMASS), Ambrosia artemisiifolia L. (common ragweed, AMBEL), Ambrosia psilostachya DC. (Western ragweed, AMBPS), Ambrosia trifida L. (giant ragweed, AMBTR), Asclepias syriaca L. (common milkweed, ASCSY), Chenopodium album L. (common lambsquarters, CHEAL), Cirsium arvense (L.) Scop. (Canada thistle, CIRAR), Commelina benghalensis L. (tropical spiderwort, COMBE), Datura stramonium L. (jimsonweed, DATST), Daucus carota L. (wild carrot, DAUCA), Euphorbia heterophylla L. (wild poinsettia, EPHHL), Erigeron bonariensis L. (hairy fleabane, ERIBO), Erigeron canadensis L. (Canadian fleabane, ERICA), Helianthus annuus L. (common sunflower, HELAN), Jacquemontia tamnifolia (L.) Griseb. (smallflower morningglory, IAQTA), Ipomoea hederacea (L.) Jacq. (ivyleaf morningglory, IPOHE), Ipomoea lacunosa L. (white morningglory, IPOLA), Lactuca serriola L./Torn. (prickly lettuce, LACSE), Portulaca oleracea L. (common purslane, POROL), Sida spinosa L. (prickly sida, SIDSP), Sinapis arvensis L. (wild mustard, SINAR), Solanum ptychanthum Dunal (eastern black nightshade, SOLPT), or Xanthium strumarium L. (common cocklebur, XANST).

In some embodiments, the compositions and methods provided herein are utilized to control undesirable vegetation consisting of grass, broadleaf and sedge weeds.

In some embodiments, the combination of compound (I) or agriculturally acceptable ester or salt thereof and a triazolopyrimidine sulfonamide herbicide or agriculturally acceptable salt or ester thereof and glyphosate or an agriculturally acceptable salt or ester thereof are used to control Commelina benghalensis L. (tropical spiderwort, COMBE), Conyza canadensis (horseweed/marestail, ERICA), Conyza bonariensis (fleabane, ERIBO), Echinochloa crus-galli (L.) P. Beauv. (barnyardgrass, ECHCG), Euphorbia heterophylla L. (wild poinsettia, EPHHL), Conyza sumatrensis (Guernsey fleabane, ERISU) and Ipomoea grandifolia (Corda-de-viola, IAQGR).

In certain embodiments of the compositions and methods described herein, the compound of formula (I) or salt or ester thereof is used in combination with a triazolopyrimidine sulfonamide herbicide or a salt or ester thereof and a glyphosate salt. With regard to the compositions, in some embodiments, the weight ratio of the compound of formula (I) or salt or ester thereof to a triazolopyrimidine sulfonamide herbicide or a salt or ester thereof and glyphosate is within the range from about 1:16:560 to about 1:1:67. In certain embodiments, the weight ratio of the compound of formula (I) or salt or ester thereof to a triazolopyrimidine sulfonamide herbicide or a salt or ester thereof and glyphosate is within the range from about 1:5:280 to about 1:1:75. In certain embodiments, the compositions provided herein contain the methyl ester of the compound of formula (I) and glyphosate as the dimethylammonium salt. In one embodiment, the composition contains the methyl ester of the compound of formula (I), a triazolopyrimidine sulfonamide herbicide or a salt or ester thereof, and glyphosate dimethylammonium salt wherein the weight ratio of the compound of formula (I) to a triazolopyrimidine sulfonamide herbicide or a salt or ester thereof to glyphosate dimethylammonium salt is from about 1:3:168 to about 3.2:1:269. In one embodiment, the composition contains the methyl ester of the compound of formula (I), a triazolopyrimidine sulfonamide herbicide or a salt or ester thereof and glyphosate dimethylammonium salt wherein the weight ratio of the methyl ester of the compound of formula (I) to a triazolopyrimidine sulfonamide herbicide or a salt or ester thereof is from about 1:200 to about 200:1. In one embodiment, the composition contains the methyl ester of the compound of formula (I), a triazolopyrimidine sulfonamide herbicide or a salt or ester thereof and glyphosate dimethylammonium salt wherein the weight ratio of the methyl ester of the compound of formula (I) to a triazolopyrimidine sulfonamide herbicide or a salt or ester thereof is from about 1:40 to about 30:1. In another embodiment, the composition contains the methyl ester of the compound of formula (I), a triazolopyrimidine sulfonamide herbicide or a salt or ester thereof and glyphosate dimethylammonium salt wherein the weight ratio of the methyl ester of the compound of formula (I) to a triazolopyrimidine sulfonamide herbicide or a salt or ester thereof is from about 1:15 to about 10:1.

In certain embodiments of the compositions and methods described herein, the compound of formula (I) or salt or ester thereof is used in combination with a triazolopyrimidine sulfonamide herbicide or a salt or ester thereof and a glyphosate salt. With regard to the compositions, in some embodiments, the weight ratio of the compound of formula (I) or salt or ester thereof plus a triazolopyrimidine sulfonamide herbicide or a salt or ester thereof and glyphosate is within the range from about 1:3360 to 0.54:1. In certain embodiments, the weight ratio of the compound of formula (I) or salt or ester thereof plus a triazolopyrimidine sulfonamide herbicide or a salt or ester thereof and glyphosate is within the range from about 1:747 to 0.196:1. In certain embodiments, the compositions provided herein contain the methyl ester of the compound of formula (I) and glyphosate as the dimethylammonium salt. In one embodiment, the composition contains the methyl ester of the compound of formula (I), a triazolopyrimidine sulfonamide herbicide or a salt or ester thereof, and glyphosate dimethylammonium salt wherein the weight ratio of the compound of formula (I) plus a triazolopyrimidine sulfonamide herbicide or a salt or ester thereof to glyphosate dimethylammonium salt is from about about 1:210 to 0.112:1. In one embodiment, the composition contains the methyl ester of the compound of formula (I), a triazolopyrimidine sulfonamide herbicide or a salt or ester thereof and glyphosate dimethylammonium salt wherein the weight ratio of the methyl ester of the compound of formula (I) to a triazolopyrimidine sulfonamide herbicide or a salt or ester thereof is from about 1:200 to about 200:1. In one embodiment, the composition contains the methyl ester of the compound of formula (I), a triazolopyrimidine sulfonamide herbicide or a salt or ester thereof and glyphosate dimethylammonium salt wherein the weight ratio of the methyl ester of the compound of formula (I) to a triazolopyrimidine sulfonamide herbicide or a salt or ester thereof is from about 1:40 to about 30:1. In another embodiment, the composition contains the methyl ester of the compound of formula (I), a triazolopyrimidine sulfonamide herbicide or a salt or ester thereof and glyphosate dimethylammonium salt wherein the weight ratio of the methyl ester of the compound of formula (I) to a triazolopyrimidine sulfonamide herbicide or a salt or ester thereof is from about 1:15 to about 10:1.

With respect to the methods, in certain embodiments, the methods include contacting the undesirable vegetation or locus thereof or applying to the soil or water to prevent the emergence or growth of vegetation a composition described herein. In some embodiments, the composition is applied at an application rate from about 280 grams active ingredient per hectare (g ai/ha) to about 3510 g ai/ha based on the total amount of active ingredients in the composition. In certain embodiments, the composition is applied at an application rate from about 563 g ai/ha to about 2350 g ai/ha based on the total amount of active ingredients in the composition. In other embodiments, the composition is applied at an application rate from about 858 g ai/ha to about 1775 g ai/ha based on the total amount of active ingredients in the composition.

In some embodiments, the methods include contacting the undesirable vegetation or locus thereof or applying to the soil or water to prevent the emergence or growth of vegetation with a compound of formula (I) or salt or ester thereof, a triazolopyrimidine sulfonamide herbicide or salt or ester thereof, and glyphosate e.g., sequentially or simultaneously. In some embodiments, the triazolopyrimidine sulfonamide herbicide or salt or ester thereof is applied at a rate from about 0.25 g ai/ha to about 100 g ai/ha, the compound of formula (I) or salt or ester thereof is applied at a rate from about 0.5 grams acid equivalent per hectare (g ae/ha) to about 50 g ae/ha, and the glyphosate is applied at a rate from about 280 g ai/ha to about 3360 g ai/ha. In some embodiments, the triazolopyrimidine sulfonamide herbicide or salt or ester thereof is applied at a rate from about 1 g ai/ha to about 80 g ai/ha, the compound of formula (I) or salt or ester thereof is applied at a rate from about 2 g ae/ha to about 30 g ae/ha, and the glyphosate is applied at a rate from about 560 g ai/ha to about 2240 g ai/ha. In certain embodiments, the methods utilize the compound of formula (I), or its methyl ester, a triazolopyrimidine sulfonamide herbicide or salt or ester thereof, and glyphosate. In one embodiment, the methods utilize the methyl ester of the compound of formula (I), a triazolopyrimidine sulfonamide herbicide or salt or ester thereof and glyphosate, wherein the methyl ester of the compound of formula (I) is applied at a rate from about 5 g ae/ha to about 20 g ae/ha, the triazolopyrimidine sulfonamide herbicide or salt or ester thereof is applied at a rate from about 2 g ai/ha to about 75 g ai/ha, and glyphosate is applied at a rate from about 840 g ai/ha to about 1680 g ai/ha.

In certain embodiments of the compositions and methods described herein, the compound of formula (I) or salt or ester thereof is used in combination with diclosulam and glyphosate. With regard to the compositions, in some embodiments, the weight ratio of the compound of formula (I) or salt or ester thereof to diclosulam to glyphosate is within the range from about 1:5:560 to about 1:2:67. In certain embodiments, the weight ratio of the compound of formula (I) or salt or ester thereof to diclosulam is within the range from about 1:200 to about 20:1. In certain embodiments, the compositions provided herein contain the methyl ester of the compound of formula (I), diclosulam, and glyphosate. In one embodiment, the composition comprises the methyl ester of the compound of formula (I), diclosulam, and glyphosate wherein the weight ratio of the compound of formula (I) to diclosulam to glyphosate is from about 1:2.5:280 to about 1:2:75. In one embodiment, the composition comprises the methyl ester of the compound of formula (I), diclosulam, and glyphosate, wherein the weight ratio of the methyl ester of the compound of formula (I) to diclosulam is from about 1:30 to about 6:1. In one embodiment, the composition contains the methyl ester of the compound of formula (I), diclosulam, and glyphosate wherein the weight ratio of the methyl ester of the compound of formula (I) to diclosulam to glyphosate is from about 1:2:168 to about 1:1.5:84. In one embodiment, the composition contains the methyl ester of the compound of formula (I), diclosulam, and glyphosate wherein the weight ratio of the methyl ester of the compound of formula (I) to diclosulam is from about 1:6 to about 2:1.

In certain embodiments of the compositions and methods described herein, the compound of formula (I) or salt or ester thereof plus diclosulam is used in combination with glyphosate. With regard to the compositions, in some embodiments, the weight ratio of the compound of formula (I) or salt or ester thereof plus diclosulam to glyphosate is within the range from about 1:1120 to about 0.54:1. In certain embodiments, the weight ratio of the compound of formula (I) or salt or ester thereof to diclosulam is within the range from about 1:200 to about 20:1. In certain embodiments, the compositions provided herein contain the methyl ester of the compound of formula (I), diclosulam, and glyphosate. In one embodiment, the composition comprises the methyl ester of the compound of formula (I), diclosulam, and glyphosate wherein the weight ratio of the compound of formula (I) plus diclosulam to glyphosate is from about 1:320 to about 0.161:1. In one embodiment, the composition comprises the methyl ester of the compound of formula (I), diclosulam, and glyphosate, wherein the weight ratio of the methyl ester of the compound of formula (I) to diclosulam is from about 1:30 to about 6:1. In one embodiment, the composition contains the methyl ester of the compound of formula (I), diclosulam, and glyphosate wherein the weight ratio of the methyl ester of the compound of formula (I) plus diclosulam to glyphosate is from about 1:112 to about 0.06:1. In one embodiment, the composition contains the methyl ester of the compound of formula (I), diclosulam, and glyphosate wherein the weight ratio of the methyl ester of the compound of formula (I) to diclosulam is from about 1:6 to about 2:1.

With respect to the methods, in certain embodiments, the methods include contacting the undesirable vegetation or locus thereof or applying to the soil or water to prevent the emergence or growth of vegetation a composition described herein. In some embodiments, the composition is applied at an application rate from about 283 grams active ingredient per hectare (g ai/ha) to about 3510 g ai/ha based on the total amount of active ingredients in the composition. In certain embodiments, the composition is applied at an application rate from about 567 g ai/ha to about 2330 g ai/ha based on the total amount of active ingredients in the composition. In other embodiments, the composition is applied at an application rate from about 855 g ai/ha to about 1730 g ai/ha based on the total amount of active ingredients in the composition.

In some embodiments, the methods include contacting the undesirable vegetation or locus thereof or applying to the soil or water to prevent the emergence or growth of vegetation with a compound of formula (I) or salt or ester thereof, diclosulam, and glyphosate e.g., sequentially or simultaneously. In some embodiments, the diclosulam is applied at a rate from about 2.5 g ai/ha to about 100 g ai/ha and the compound of formula (I) or salt or ester thereof is applied at a rate from about 0.5 grams acid equivalent per hectare (g ae/ha) to about 50 g ae/ha and the glyphosate is applied at a rate from about 280 g ai/ha to 3360 g ai/ha. In some embodiments, the diclosulam is applied at a rate from about 5 g ai/ha to about 60 g ai/ha, the compound of formula (I) or salt or ester thereof is applied at a rate from about 2 g ae/ha to about 30 g ae/ha, and the glyphosate is applied at a rate from about 560 g ai/ha to 2240 g ai/ha. In certain embodiments, the methods utilize the compound of formula (I) or its methyl ester and diclosulam. In one embodiment, the methods utilize the methyl ester of the compound of formula (I), diclosulam, and glyphosate, wherein the methyl ester of the compound of formula (I) is applied at a rate from about 5 g ae/ha to about 20 g ae/ha, diclosulam is applied at a rate from about 10 g ai/ha to about 30 g ai/ha, and the glyphosate is applied at a rate from about 840 g ai/ha to about 1680 g ai/ha.

In certain embodiments of the compositions and methods described herein, the compound of formula (I) or salt or ester thereof is used in combination with florasulam and glyphosate. With regard to the compositions, in some embodiments, the weight ratio of the compound of formula (I) or salt or ester thereof to florasulam to glyphosate is within the range from about 2:1:1120 to about 1.67:1:112. In certain embodiments, the weight ratio of the compound of formula (I) or salt or ester thereof to florasulam is within the range from about 1:60 to about 200:1. In certain embodiments, the compositions provided herein contain the methyl ester of the compound of formula (I), florasulam, and glyphosate. In one embodiment, the composition comprises the methyl ester of the compound of formula (I), florasulam, and glyphosate wherein the weight ratio of the compound of formula (I) to florasulam to glyphosate is from about 2:1:560 to about 2:1:149. In one embodiment, the composition comprises the methyl ester of the compound of formula (I), florasulam, and glyphosate, wherein the weight ratio of the methyl ester of the compound of formula (I) to florasulam is from about 1:7.5 to about 30:1. In one embodiment, the composition contains the methyl ester of the compound of formula (I), florasulam, and glyphosate wherein the weight ratio of the methyl ester of the compound of formula (I) to florasulam to glyphosate is from about 1.67:1:280 to about 3.2:1:268. In one embodiment, the composition contains the methyl ester of the compound of formula (I), florasulam, and glyphosate wherein the weight ratio of the methyl ester of the compound of formula (I) to florasulam is from about 1:1.25 to about 6.7:1.

In certain embodiments of the compositions and methods described herein, the compound of formula (I) or salt or ester thereof is used in combination with florasulam and glyphosate. With regard to the compositions, in some embodiments, the weight ratio of the compound of formula (I) or salt or ester thereof plus florasulam to glyphosate is within the range from about 1:4480 to about 0.286:1. In certain embodiments, the weight ratio of the compound of formula (I) or salt or ester thereof to florasulam is within the range from about 1:60 to about 200:1. In certain embodiments, the compositions provided herein contain the methyl ester of the compound of formula (I), florasulam, and glyphosate. In one embodiment, the composition comprises the methyl ester of the compound of formula (I), florasulam, and glyphos ate wherein the weight ratio of the compound of formula (I) plus florasulam to glyphosate is from about 1:747 to about 0.08:1. In one embodiment, the composition comprises the methyl ester of the compound of formula (I), florasulam, and glyphosate, wherein the weight ratio of the methyl ester of the compound of formula (I) to florasulam is from about 1:7.5 to about 30:1. In one embodiment, the composition contains the methyl ester of the compound of formula (I), florasulam, and glyphosate wherein the weight ratio of the methyl ester of the compound of formula (I) plus florasulam to glyphosate is from about 1:210 to about 0.031:1. In one embodiment, the composition contains the methyl ester of the compound of formula (I), florasulam, and glyphosate wherein the weight ratio of the methyl ester of the compound of formula (I) to florasulam is from about 1:1.25 to about 6.7:1.

With respect to the methods, in certain embodiments, the methods include contacting the undesirable vegetation or locus thereof or applying to the soil or water to prevent the emergence or growth of vegetation a composition described herein. In some embodiments, the composition is applied at an application rate from about 280 grams active ingredient per hectare (g ai/ha) to about 3440 g ai/ha based on the total amount of active ingredients in the composition. In certain embodiments, the composition is applied at an application rate from about 563 g ai/ha to about 2285 g ai/ha based on the total amount of active ingredients in the composition. In other embodiments, the composition is applied at an application rate from about 848 g ai/ha to about 1707 g ai/ha based on the total amount of active ingredients in the composition.

In some embodiments, the methods include contacting the undesirable vegetation or locus thereof or applying to the soil or water to prevent the emergence or growth of vegetation with a compound of formula (I) or salt or ester thereof, florasulam, and glyphosate e.g., sequentially or simultaneously. In some embodiments, the florasulam is applied at a rate from about 0.25 g ai/ha to about 30 g ai/ha and the compound of formula (I) or salt or ester thereof is applied at a rate from about 0.5 grams acid equivalent per hectare (g ae/ha) to about 50 g ae/ha and the glyphosate is applied at a rate from about 280 g ai/ha to about 3360 g ai/ha. In some embodiments, the florasulam is applied at a rate from about 1 g ai/ha to about 15 g ai/ha, the compound of formula (I) or salt or ester thereof is applied at a rate from about 2 g ae/ha to about 30 g ae/ha, and the glyphosate is applied at a rate from about 560 g ai/ha to 2240 g ai/ha. In certain embodiments, the methods utilize the compound of formula (I) or its methyl ester and florasulam. In one embodiment, the methods utilize the methyl ester of the compound of formula (I), florasulam, and glyphosate, wherein the methyl ester of the compound of formula (I) is applied at a rate from about 5 g ae/ha to about 20 g ae/ha, florasulam is applied at a rate from about 3 g ai/ha to about 6.25 g ai/ha, and the glyphosate is applied at a rate from about 840 g ai/ha to about 1680 g ai/ha.

In certain embodiments of the compositions and methods described herein, the compound of formula (I) or salt or ester thereof is used in combination with pyroxsulam and glyphosate. With regard to the compositions, in some embodiments, the weight ratio of the compound of formula (I) or salt or ester thereof to pyroxsulam to glyphosate is within the range from about 1:1:560 to about 1:1:67. In certain embodiments, the weight ratio of the compound of formula (I) or salt or ester thereof to pyroxsulam is within the range from about 1:100 to about 100:1. In certain embodiments, the compositions provided herein contain the methyl ester of the compound of formula (I), pyroxsulam, and glyphosate. In one embodiment, the composition comprises the methyl ester of the compound of formula (I), pyroxsulam, and glyphosate wherein the weight ratio of the compound of formula (I) to pyroxsulam to glyphosate is from about 1:1:280 to about 1.2:1:90. In one embodiment, the composition comprises the methyl ester of the compound of formula (I), pyroxsulam, and glyphosate, wherein the weight ratio of the methyl ester of the compound of formula (I) to pyroxsulam is from about 1:12.5 to about 15:1. In one embodiment, the composition contains the methyl ester of the compound of formula (I), pyroxsulam, and glyphosate wherein the weight ratio of the methyl ester of the compound of formula (I) to pyroxsulam to glyphosate is from about 1:1.92:168 to about 1.07:1:90. In one embodiment, the composition contains the methyl ester of the compound of formula (I), pyroxsulam, and glyphosate wherein the weight ratio of the methyl ester of the compound of formula (I) to pyroxsulam is from about 1:3.75 to about 2.1:1.

In certain embodiments of the compositions and methods described herein, the compound of formula (I) or salt or ester thereof is used in combination with pyroxsulam and glyphosate. With regard to the compositions, in some embodiments, the weight ratio of the compound of formula (I) or salt or ester thereof plus pyroxsulam to glyphosate is within the range from about 1:3360 to about 0.357:1. In certain embodiments, the weight ratio of the compound of formula (I) or salt or ester thereof to pyroxsulam is within the range from about 1:100 to about 100:1. In certain embodiments, the compositions provided herein contain the methyl ester of the compound of formula (I), pyroxsulam, and glyphosate. In one embodiment, the composition comprises the methyl ester of the compound of formula (I), pyroxsulam, and glyphosate wherein the weight ratio of the compound of formula (I) plus pyroxsulam to glyphosate is from about 1:560 to about 0.098:1. In one embodiment, the composition comprises the methyl ester of the compound of formula (I), pyroxsulam, and glyphosate, wherein the weight ratio of the methyl ester of the compound of formula (I) to pyroxsulam is from about 1:12.5 to about 15:1. In one embodiment, the composition contains the methyl ester of the compound of formula (I), pyroxsulam, and glyphosate wherein the weight ratio of the methyl ester of the compound of formula (I) to pyroxsulam to glyphosate is from about 1:1.92:168 to about 1.07:1:90. In one embodiment, the composition contains the methyl ester of the compound of formula (I), pyroxsulam, and glyphosate wherein the weight ratio of the methyl ester of the compound of formula (I) plus pyroxsulam is from about 1:115 to about 0.046:1.

With respect to the methods, in certain embodiments, the methods include contacting the undesirable vegetation or locus thereof or applying to the soil or water to prevent the emergence or growth of vegetation a composition described herein. In some embodiments, the composition is applied at an application rate from about 281 grams active ingredient per hectare (g ai/ha) to about 3460 g ai/ha based on the total amount of active ingredients in the composition. In certain embodiments, the composition is applied at an application rate from about 564 g ai/ha to about 2295 g ai/ha based on the total amount of active ingredients in the composition. In other embodiments, the composition is applied at an application rate from about 854 g ai/ha to about 1719 g ai/ha based on the total amount of active ingredients in the composition.

In some embodiments, the methods include contacting the undesirable vegetation or locus thereof or applying to the soil or water to prevent the emergence or growth of vegetation with a compound of formula (I) or salt or ester thereof, pyroxsulam, and glyphosate e.g., sequentially or simultaneously. In some embodiments, the pyroxsulam is applied at a rate from about 0.5 g ai/ha to about 50 g ai/ha and the compound of formula (I) or salt or ester thereof is applied at a rate from about 0.5 grams acid equivalent per hectare (g ae/ha) to about 50 g ae/ha and the glyphosate is applied at a rate from about 280 gr ai/ha to about 3360 g ai/ha. In some embodiments, the pyroxsulam is applied at a rate from about 2 g ai/ha to about 25 g ai/ha, the compound of formula (I) or salt or ester thereof is applied at a rate from about 2 g ae/ha to about 30 g ae/ha, and the glyphosate is applied at a rate from about 560 g ai/ha to about 2240 g ai/ha. In certain embodiments, the methods utilize the compound of formula (I) or its methyl ester and pyroxsulam. In one embodiment, the methods utilize the methyl ester of the compound of formula (I), pyroxsulam, and glyphosate, wherein the methyl ester of the compound of formula (I) is applied at a rate from about 5 g ae/ha to about 20 g ae/ha, pyroxsulam is applied at a rate from about 9.6 g ai/ha to about 18.75 g ai/ha, and the glyphosate is applied at a rate from about 840 g ai/ha to about 1680 g ai/ha.

In certain embodiments of the compositions and methods described herein, the compound of formula (I) or salt or ester thereof is used in combination with cloransulam and glyphosate. With regard to the compositions, in some embodiments, the weight ratio of the compound of formula (I) or salt or ester thereof to cloransulam to glyphosate is within the range from about 1:16:560 to about 1:2:67.2. In certain embodiments, the weight ratio of the compound of formula (I) or salt or ester thereof to cloransulam is within the range from about 1:200 to about 6.25:1. In certain embodiments, the compositions provided herein contain the methyl ester of the compound of formula (I), cloransulam, and glyphosate. In one embodiment, the composition comprises the methyl ester of the compound of formula (I), cloransulam, and glyphosate wherein the weight ratio of the compound of formula (I) to cloransulam to glyphosate is from about 1:5:280 to about 1:2.67:75. In one embodiment, the composition comprises the methyl ester of the compound of formula (I), cloransulam, and glyphosate, wherein the weight ratio of the methyl ester of the compound of formula (I) to cloransulam is from about 1:40 to about 3:1. In one embodiment, the composition contains the methyl ester of the compound of formula (I), cloransulam, and glyphosate wherein the weight ratio of the methyl ester of the compound of formula (I) to cloransulam to glyphosate is from about 1:3:168 to about 1:3.75:84. In one embodiment, the composition contains the methyl ester of the compound of formula (I), cloransulam, and glyphosate wherein the weight ratio of the methyl ester of the compound of formula (I) to cloransulam is from about 1:15 to about 1.33:1.

In certain embodiments of the compositions and methods described herein, the compound of formula (I) or salt or ester thereof is used in combination with cloransulam and glyphosate. With regard to the compositions, in some embodiments, the weight ratio of the compound of formula (I) or salt or ester thereof plus cloransulam to glyphosate is within the range from about 1:16:560 to about 1:2:67.2. In certain embodiments, the weight ratio of the compound of formula (I) or salt or ester thereof to cloransulam is within the range from about 1:200 to about 6.25:1. In certain embodiments, the compositions provided herein contain the methyl ester of the compound of formula (I), cloransulam, and glyphosate. In one embodiment, the composition comprises the methyl ester of the compound of formula (I), cloransulam, and glyphosate wherein the weight ratio of the compound of formula (I) plus cloransulam to glyphosate is from about 1:187 to about 0.196:1. In one embodiment, the composition comprises the methyl ester of the compound of formula (I), cloransulam, and glyphosate, wherein the weight ratio of the methyl ester of the compound of formula (I) to cloransulam is from about 1:40 to about 3:1. In one embodiment, the composition contains the methyl ester of the compound of formula (I), cloransulam, and glyphosate wherein the weight ratio of the methyl ester of the compound of formula (I) to cloransulam to glyphosate is from about 1:84 to about 0.113:1. In one embodiment, the composition contains the methyl ester of the compound of formula (I), cloransulam, and glyphos ate wherein the weight ratio of the methyl ester of the compound of formula (I) to cloransulam is from about 1:15 to about 1.33:1.

With respect to the methods, in certain embodiments, the methods include contacting the undesirable vegetation or locus thereof or applying to the soil or water to prevent the emergence or growth of vegetation a composition described herein. In some embodiments, the composition is applied at an application rate from about 288 grams active ingredient per hectare (g ai/ha) to about 3510 g ai/ha based on the total amount of active ingredients in the composition. In certain embodiments, the composition is applied at an application rate from about 572 g ai/ha to about 2350 g ai/ha based on the total amount of active ingredients in the composition. In other embodiments, the composition is applied at an application rate from about 860 g ai/ha to about 1775 g ai/ha based on the total amount of active ingredients in the composition.

In some embodiments, the methods include contacting the undesirable vegetation or locus thereof or applying to the soil or water to prevent the emergence or growth of vegetation with a compound of formula (I) or salt or ester thereof, cloransulam, and glyphosate e.g., sequentially or simultaneously. In some embodiments, the cloransulam is applied at a rate from about 8 g ai/ha to about 100 g ai/ha and the compound of formula (I) or salt or ester thereof is applied at a rate from about 0.5 grams acid equivalent per hectare (g ae/ha) to about 50 g ae/ha and the glyphosate is applied at a rate from about 280 g ai/ha to about 3360 g ai/ha. In some embodiments, the cloransulam is applied at a rate from about 10 g ai/ha to about 80 g ai/ha, the compound of formula (I) or salt or ester thereof is applied at a rate from about 2 g ae/ha to about 30 g ae/ha, and the glyphosate is applied at a rate from about 560 g ai/ha to about 2240 g ai/ha. In certain embodiments, the methods utilize the compound of formula (I) or its methyl ester and cloransulam. In one embodiment, the methods utilize the methyl ester of the compound of formula (I), cloransulam, and glyphosate, wherein the methyl ester of the compound of formula (I) is applied at a rate from about 5 g ae/ha to about 20 g ae/ha, cloransulam is applied at a rate from about 15 g ai/ha to about 75 g ai/ha, and the glyphosate is applied at a rate from about 840 g ai/ha to about 1680 g ai/ha.

In certain embodiments of the compositions and methods described herein, the compound of formula (I) or salt or ester thereof is used in combination with flumetsulam and glyphosate. With regard to the compositions, in some embodiments, the weight ratio of the compound of formula (I) or salt or ester thereof to flumetsulam to glyphosate is within the range from about 1:16:560 to about 1:2:67.2. In certain embodiments, the weight ratio of the compound of formula (I) or salt or ester thereof to flumetsulam is within the range from about 1:200 to about 6.25:1. In certain embodiments, the compositions provided herein contain the methyl ester of the compound of formula (I), flumetsulam, and glyphosate. In one embodiment, the composition comprises the methyl ester of the compound of formula (I), flumetsulam, and glyphosate wherein the weight ratio of the compound of formula (I) to flumetsulam to glyphosate is from about 1:5:280 to about 1:2.67:75. In one embodiment, the composition comprises the methyl ester of the compound of formula (I), flumetsulam, and glyphosate, wherein the weight ratio of the methyl ester of the compound of formula (I) to flumetsulam is from about 1:40 to about 3:1. In one embodiment, the composition contains the methyl ester of the compound of formula (I), flumetsulam, and glyphosate wherein the weight ratio of the methyl ester of the compound of formula (I) to flumetsulam to glyphosate is from about 1:3:168 to about 1:3.75:84. In one embodiment, the composition contains the methyl ester of the compound of formula (I), flumetsulam, and glyphosate wherein the weight ratio of the methyl ester of the compound of formula (I) to flumetsulam is from about 1:15 to about 1.33:1.

In certain embodiments of the compositions and methods described herein, the compound of formula (I) or salt or ester thereof is used in combination with flumetsulam and glyphosate. With regard to the compositions, in some embodiments, the weight ratio of the compound of formula (I) or salt or ester thereof plus flumetsulam to glyphosate is within the range from about 1:395 to about 0.536:1. In certain embodiments, the weight ratio of the compound of formula (I) or salt or ester thereof to flumetsulam is within the range from about 1:200 to about 6.25:1. In certain embodiments, the compositions provided herein contain the methyl ester of the compound of formula (I), flumetsulam, and glyphosate. In one embodiment, the composition comprises the methyl ester of the compound of formula (I), flumetsulam, and glyphosate wherein the weight ratio of the compound of formula (I) plus flumetsulam to glyphosate is from about 1:187 to about 0.196:1. In one embodiment, the composition comprises the methyl ester of the compound of formula (I), flumetsulam, and glyphosate, wherein the weight ratio of the methyl ester of the compound of formula (I) to flumetsulam is from about 1:40 to about 3:1. In one embodiment, the composition contains the methyl ester of the compound of formula (I), flumetsulam, and glyphosate wherein the weight ratio of the methyl ester of the compound of formula (I) plus flumetsulam to glyphos ate is from about 1:84 to about 0.113:1. In one embodiment, the composition contains the methyl ester of the compound of formula (I), flumetsulam, and glyphosate wherein the weight ratio of the methyl ester of the compound of formula (I) to flumetsulam is from about 1:15 to about 1.33:1.

With respect to the methods, in certain embodiments, the methods include contacting the undesirable vegetation or locus thereof or applying to the soil or water to prevent the emergence or growth of vegetation a composition described herein. In some embodiments, the composition is applied at an application rate from about 288 grams active ingredient per hectare (g ai/ha) to about 3510 g ai/ha based on the total amount of active ingredients in the composition. In certain embodiments, the composition is applied at an application rate from about 572 g ai/ha to about 2350 g ai/ha based on the total amount of active ingredients in the composition. In other embodiments, the composition is applied at an application rate from about 860 g ai/ha to about 1775 g ai/ha based on the total amount of active ingredients in the composition.

In some embodiments, the methods include contacting the undesirable vegetation or locus thereof or applying to the soil or water to prevent the emergence or growth of vegetation with a compound of formula (I) or salt or ester thereof, flumetsulam, and glyphosate e.g., sequentially or simultaneously. In some embodiments, the flumetsulam is applied at a rate from about 8 g ai/ha to about 100 g ai/ha and the compound of formula (I) or salt or ester thereof is applied at a rate from about 0.5 grams acid equivalent per hectare (g ae/ha) to about 50 g ae/ha and the glyphosate is applied at a rate from about 280 g ai/ha to about 3360 g ai/ha. In some embodiments, the flumetsulam is applied at a rate from about 10 g ai/ha to about 80 g ai/ha, the compound of formula (I) or salt or ester thereof is applied at a rate from about 2 g ae/ha to about 30 g ae/ha, and the glyphosate is applied at a rate from about 560 g ai/ha to about 2240 g ai/ha. In certain embodiments, the methods utilize the compound of formula (I) or its methyl ester and cloransulam. In one embodiment, the methods utilize the methyl ester of the compound of formula (I), flumetsulam, and glyphosate, wherein the methyl ester of the compound of formula (I) is applied at a rate from about 5 g ae/ha to about 20 g ae/ha, flumetsulam is applied at a rate from about 15 g ai/ha to about 75 g ai/ha, and the glyphosate is applied at a rate from about 840 g ai/ha to about 1680 g ai/ha.

In certain embodiments of the compositions and methods described herein, the compound of formula (I) or salt or ester thereof is used in combination with metosulam and glyphosate. With regard to the compositions, in some embodiments, the weight ratio of the compound of formula (I) or salt or ester thereof to metosulam to glyphosate is within the range from about 1:2:560 to about 1:1:67. In certain embodiments, the weight ratio of the compound of formula (I) or salt or ester thereof to metosulam is within the range from about 1:100 to about 50:1. In certain embodiments, the compositions provided herein contain the methyl ester of the compound of formula (I), metosulam, and glyphosate. In one embodiment, the composition comprises the methyl ester of the compound of formula (I), metosulam, and glyphosate wherein the weight ratio of the compound of formula (I) to metosulam to glyphosate is from about 1.14:1:320 to about 1:1:75. In one embodiment, the composition comprises the methyl ester of the compound of formula (I), metosulam, and glyphosate, wherein the weight ratio of the methyl ester of the compound of formula (I) to metosulam is from about 1:15 to about 17:1. In one embodiment, the composition contains the methyl ester of the compound of formula (I), metosulam, and glyphosate wherein the weight ratio of the methyl ester of the compound of formula (I) to metosulam to glyphosate is from about 2.5:1:420 to about 1:1.25:84. In one embodiment, the composition contains the methyl ester of the compound of formula (I), metosulam, and glyphosate wherein the weight ratio of the methyl ester of the compound of formula (I) to metosulam is from about 1:5 to about 10:1.

In certain embodiments of the compositions and methods described herein, the compound of formula (I) or salt or ester thereof is used in combination with metosulam and glyphosate. With regard to the compositions, in some embodiments, the weight ratio of the compound of formula (I) or salt or ester thereof plus metosulam to glyphosate is within the range from about 1:2240 to about 0.357:1. In certain embodiments, the weight ratio of the compound of formula (I) or salt or ester thereof to metosulam is within the range from about 1:100 to about 50:1. In certain embodiments, the compositions provided herein contain the methyl ester of the compound of formula (I), metosulam, and glyphosate. In one embodiment, the composition comprises the methyl ester of the compound of formula (I), metosulam, and glyphosate wherein the weight ratio of the compound of formula (I) plus metosulam to glyphosate is from about 1:678 to about 0.125:1. In one embodiment, the composition comprises the methyl ester of the compound of formula (I), metosulam, and glyphosate, wherein the weight ratio of the methyl ester of the compound of formula (I) to metosulam is from about 1:15 to about 17:1. In one embodiment, the composition contains the methyl ester of the compound of formula (I), metosulam, and glyphosate wherein the weight ratio of the methyl ester of the compound of formula (I) plus metosulam to glyphosate is from about 1:240 to about 0.054:1. In one embodiment, the composition contains the methyl ester of the compound of formula (I), metosulam, and glyphosate wherein the weight ratio of the methyl ester of the compound of formula (I) to metosulam is from about 1:5 to about 10:1.

With respect to the methods, in certain embodiments, the methods include contacting the undesirable vegetation or locus thereof or applying to the soil or water to prevent the emergence or growth of vegetation a composition described herein. In some embodiments, the composition is applied at an application rate from about 281 grams active ingredient per hectare (g ai/ha) to about 3460 g ai/ha based on the total amount of active ingredients in the composition. In certain embodiments, the composition is applied at an application rate from about 563 g ai/ha to about 2300 g ai/ha based on the total amount of active ingredients in the composition. In other embodiments, the composition is applied at an application rate from about 847 g ai/ha to about 1725 g ai/ha based on the total amount of active ingredients in the composition.

In some embodiments, the methods include contacting the undesirable vegetation or locus thereof or applying to the soil or water to prevent the emergence or growth of vegetation with a compound of formula (I) or salt or ester thereof, metosulam, and glyphosate e.g., sequentially or simultaneously. In some embodiments, the metosulam is applied at a rate from about 1 g ai/ha to about 50 g ai/ha and the compound of formula (I) or salt or ester thereof is applied at a rate from about 0.5 grams acid equivalent per hectare (g ae/ha) to about 50 g ae/ha and the glyphosate is applied at a rate from about 280 g ai/ha to 3360 g ai/ha. In some embodiments, the metosulam is applied at a rate from about 1.75 g ai/ha to about 30 g ai/ha, the compound of formula (I) or salt or ester thereof is applied at a rate from about 2 g ae/ha to about 30 g ae/ha, and the glyphosate is applied at a rate from about 560 g ai/ha to 2240 g ai/ha. In certain embodiments, the methods utilize the compound of formula (I) or its methyl ester and metosulam. In one embodiment, the methods utilize the methyl ester of the compound of formula (I), metosulam, and glyphosate, wherein the methyl ester of the compound of formula (I) is applied at a rate from about 5 g ae/ha to about 20 g ae/ha, metosulam is applied at a rate from about 2 g ai/ha to about 25 g ai/ha, and the glyphosate is applied at a rate from about 840 g ai/ha to about 1680 g ai/ha.

In certain embodiments of the compositions and methods described herein, the compound of formula (I) or salt or ester thereof is used in combination with penoxsulam and glyphosate. With regard to the compositions, in some embodiments, the weight ratio of the compound of formula (I) or salt or ester thereof to penoxsulam to glyphosate is within the range from about 1:5:560 to about 1:2:67. In certain embodiments, the weight ratio of the compound of formula (I) or salt or ester thereof to penoxsulam is within the range from about 1:200 to about 20:1. In certain embodiments, the compositions provided herein contain the methyl ester of the compound of formula (I), penoxsulam, and glyphosate. In one embodiment, the composition comprises the methyl ester of the compound of formula (I), penoxsulam, and glyphos ate wherein the weight ratio of the compound of formula (I) to penoxsulam to glyphosate is from about 1:2.5:280 to about 1:1.67:75. In one embodiment, the composition comprises the methyl ester of the compound of formula (I), penoxsulam, and glyphosate, wherein the weight ratio of the methyl ester of the compound of formula (I) to penoxsulam is from about 1:25 to about 6:1. In one embodiment, the composition contains the methyl ester of the compound of formula (I), penoxsulam, and glyphosate wherein the weight ratio of the methyl ester of the compound of formula (I) to penoxsulam to glyphos ate is from about 1:1.5:168 to about 1:2.4:84. In one embodiment, the composition contains the methyl ester of the compound of formula (I), penoxsulam, and glyphosate wherein the weight ratio of the methyl ester of the compound of formula (I) to penoxsulam is from about 1:9.6 to about 2.67:1.

In certain embodiments of the compositions and methods described herein, the compound of formula (I) or salt or ester thereof is used in combination with penoxsulam and glyphosate. With regard to the compositions, in some embodiments, the weight ratio of the compound of formula (I) or salt or ester thereof plus penoxsulam to glyphosate is within the range from about 1:1120 to about 0.446:1. In certain embodiments, the weight ratio of the compound of formula (I) or salt or ester thereof to penoxsulam is within the range from about 1:200 to about 20:1. In certain embodiments, the compositions provided herein contain the methyl ester of the compound of formula (I), penoxsulam, and glyphosate. In one embodiment, the composition comprises the methyl ester of the compound of formula (I), penoxsulam, and glyphosate wherein the weight ratio of the compound of formula (I) plus penoxsulam to glyphosate is from about 1:389 to about 0.161:1. In one embodiment, the composition comprises the methyl ester of the compound of formula (I), penoxsulam, and glyphosate, wherein the weight ratio of the methyl ester of the compound of formula (I) to penoxsulam is from about 1:25 to about 6:1. In one embodiment, the composition contains the methyl ester of the compound of formula (I), penoxsulam, and glyphosate wherein the weight ratio of the methyl ester of the compound of formula (I) to penoxsulam to glyphos ate is from about 1:168 to about 0.083:1. In one embodiment, the composition contains the methyl ester of the compound of formula (I), penoxsulam, and glyphosate wherein the weight ratio of the methyl ester of the compound of formula (I) to penoxsulam is from about 1:9.6 to about 2.67:1.

With respect to the methods, in certain embodiments, the methods include contacting the undesirable vegetation or locus thereof or applying to the soil or water to prevent the emergence or growth of vegetation a composition described herein. In some embodiments, the composition is applied at an application rate from about 283 grams active ingredient per hectare (g ai/ha) to about 3510 g ai/ha based on the total amount of active ingredients in the composition. In certain embodiments, the composition is applied at an application rate from about 567 g ai/ha to about 2330 g ai/ha based on the total amount of active ingredients in the composition. In other embodiments, the composition is applied at an application rate from about 850 g ai/ha to about 1750 g ai/ha based on the total amount of active ingredients in the composition.

In some embodiments, the methods include contacting the undesirable vegetation or locus thereof or applying to the soil or water to prevent the emergence or growth of vegetation with a compound of formula (I) or salt or ester thereof, penoxsulam, and glyphosate e.g., sequentially or simultaneously. In some embodiments, the penoxsulam is applied at a rate from about 2.5 g ai/ha to about 100 g ai/ha and the compound of formula (I) or salt or ester thereof is applied at a rate from about 0.5 grams acid equivalent per hectare (g ae/ha) to about 50 g ae/ha and the glyphosate is applied at a rate from about 280 g ai/ha to about 3360 g ai/ha. In some embodiments, the penoxsulam is applied at a rate from about 5 g ai/ha to about 50 g ai/ha, the compound of formula (I) or salt or ester thereof is applied at a rate from about 2 g ae/ha to about 30 g ae/ha, and the glyphosate is applied at a rate from about 560 g ai/ha to about 2240 g ai/ha. In certain embodiments, the methods utilize the compound of formula (I) or its methyl ester and penoxsulam. In one embodiment, the methods utilize the methyl ester of the compound of formula (I), penoxsulam, and glyphosate, wherein the methyl ester of the compound of formula (I) is applied at a rate from about 5 g ae/ha to about 20 g ae/ha, penoxsulam is applied at a rate from about 7.5 g ai/ha to about 48 g ai/ha, and the glyphosate is applied at a rate from about 840 g ai/ha to about 1680 g ai/ha.

The components of the mixtures described herein can be applied either separately or as part of a multipart herbicidal system. In some embodiments of the methods described herein, the active ingredients are applied simultaneously, including, e.g., in the form of a composition. In some embodiments, the active ingredients are applied sequentially, e.g., within 5, 10, 15, or 30 minutes of each other; or 1, 2, 3, 4, 5, 10, 12, 24, 48, 72 hour(s) of each other; or 1 week of each other.

The present compositions can be applied to weeds and other undesirable vegetation, or to their locus thereof by the use of conventional ground or aerial dusters, sprayers, and granule applicators and by other conventional means known to those skilled in the art.

The described embodiments and following examples are for illustrative purposes and are not intended to limit the scope of the claims. Other modifications, uses, or combinations with respect to the compositions described herein will be apparent to a person of ordinary skill in the art without departing from the spirit and scope of the claimed subject matter.

### EXAMPLES

### EXAMPLE 1

### Evaluation of Postemergence Herbicidal Activity

Treatments consisted of the methyl ester of 4-amino-3-chloro-6-(4-chloro-2-fluoro-3-methoxyphenyl)pyridine-2-carboxylic acid (Cmpd 1) and diclosulam in combination as GF-3220. The form of compound of formula (I) was applied on an acid equivalent basis, and diclosulam was applied on an active ingredient basis. Glyphosate dimethylammonium salt was applied as various commercial formulations containing 480 grams acid equivalent per liter (g ae/L).

Field trials were conducted under standard field conditions. Plot sizes varied from 3-4 meters (m) wide by 5-10 m long. Treatments were applied with small plot backpack sprayers, using pressurized carbon dioxide (CO2) as propellant. Pressure varied from 30-50 pounds per square inch (PSI), with spray tips typically of a Flat Fan type applying water diluent at 100-150 liters per hectare (L/ha). Boom sizes varied from 3-4 m in width. Weed sizes varied, but all treatments were applied as post-emergence treatments to weeds from 2 leaf to 2 tiller growth stages varying from 2-15 inches in height. No additional adjuvant was mixed with the treatments applied in the field.

The weed spectrum included, but was not limited to, Commelina benghalensis (hairy wandering Jew, COMBE), Echinochloa crus-galli (barnyardgrass, ECHCG), Euphorbia heterophylla (wild poinsettia, EPHHL), Conyza bonariensis (hairy fleabane, ERIBO), Conyza canadensis (horseweed, ERICA), Conyza sumatrensis (Guernsey fleabane, ERISU) and Ipomoea grandifolia (Corda-de-viola, IAQGR).

Results in Tables 1 to 4 are field trial results for foliar applied compositions. The values reported are percent (%) control visually rated. The predicted percent (%) weed control was determined using Colby's equation.

The compositions tested, application rates employed, plant species tested, and results are given in Tables 1 to 4.
The following abbreviations are used in Tables 1 to 4:
COMBE=Commelina benghalensis (hairy wandering Jew)
ECHCG=Echinochloa crus-galli (barnyardgrass)
EPHHL=Euphorbia heterophylla (wild poinsettia)
ERIBO=Conyza bonariensis (hairy fleabane)
ERICA=Conyza canadensis (horseweed)
ERISU=Conyza sumatrensis (Guernsey fleabane)
IAQGR=Ipomoea grandifolia (Corda-de-viola)
g ae/ha=grams acid equivalent per hectare
g ai/ha=grams active ingredient per hectare
DAA=days after application
Mean % weed control=observed value of percent (%) control rated visually
Predicted mean % weed control=expected value of percent (%) control as calculated by Colby's equation
Cmpd 1=methyl 4-amino-3-chloro-6-(4-chloro-2-fluoro-3-methoxyphenyl)pyridine-2-carboxylate, halauxifen-methyl, or ARYLEX®

TABLE 1
Weed control from post-emergence application of Cmpd 1 (Halauxifen-methyl) and
diclosulam premix when tank-mixed with glyphosate DMA.

| | | Cmpd 1 + | | Glyphosate | | Combination | |
|---|---|---|---|---|---|---|---|
| | | Diclosulam | | DMA salt | | | Predicted |
| | | | Mean % | | Mean % | Measured | mean % |
| Weed | Evaluation | | weed | | weed | mean % | weed |
| Bayer | Interval | g ai/ha | control | g ai/ha | control | weed control | control |
| COMBE | 35DAA | 32.7 | 91.0 | 960 | 62.0 | 100 | 96.83 |
| COMBE | 35DAA | 39.0 | 73.3 | 960 | 62.0 | 99.33 | 90.93 |
| ECHCG | 18DAA | 20.0 | 31.7 | 1200 | 16.7 | 83.33 | 43.08 |
| ECHCG | 18DAA | 30.0 | 38.3 | 1200 | 16.7 | 87.67 | 48.67 |
| ECHCG | 18DAA | 36.0 | 41.7 | 1200 | 16.7 | 92.33 | 51.5 |
| ECHCG | 38DAA | 36.0 | 47.3 | 1200 | 16.7 | 74 | 56.65 |
| IAQGR | 14DAA | 30.6 | 47.5 | 960 | 40.0 | 86.5 | 68.75 |
| IAQGR | 19DAA | 30.6 | 65.0 | 960 | 43.8 | 91 | 80.44 |
| IAQGR | 28DAA | 30.6 | 68.8 | 960 | 45.0 | 92.5 | 82.44 |
| IAQGR | 35DAA | 30.6 | 67.5 | 960 | 53.8 | 97 | 84.81 |
| IAQGR | 42DAA | 30.6 | 63.8 | 960 | 48.8 | 95.5 | 81.5 |

TABLE 2
Weed control from post-emergence application of Cmpd 1 (Halauxifen-methyl) and
diclosulam premix when tank-mixed with glyphosate DMA.

| | | Cmpd 1 + | | Glyphosate | | Combination | |
|---|---|---|---|---|---|---|---|
| | | Diclosulam | | DMA salt | | | Predicted |
| | | | Mean % | | Mean % | Measured | mean % |
| Weed | Evaluation | | weed | | weed | mean % weed | weed |
| Bayer | Interval | g ai/ha | control | g ai/ha | control | control | control |
| EPHHL | 7DAA | 35.2 | 58.8 | 960 | 38.8 | 85 | 74.56 |
| EPHHL | 7DAA | 36.0 | 67.5 | 960 | 38.8 | 87.5 | 80.19 |
| EPHHL | 7DAA | 42.0 | 70.0 | 960 | 38.8 | 87.5 | 81.56 |
| EPHHL | 14DAA | 21.8 | 68.8 | 960 | 52.5 | 96.25 | 85.12 |
| EPHHL | 14DAA | 23.5 | 72.5 | 960 | 52.5 | 96.25 | 86.88 |
| EPHHL | 14DAA | 30.2 | 70.0 | 960 | 52.5 | 97.5 | 85.5 |
| EPHHL | 14DAA | 36.0 | 71.3 | 960 | 52.5 | 98.75 | 86.75 |
| EPHHL | 14DAA | 42.0 | 75.0 | 960 | 52.5 | 97.5 | 87.94 |
| EPHHL | 28DAA | 36.0 | 77.5 | 960 | 18.8 | 90 | 81.75 |
| EPHHL | 35DAA | 20.1 | 43.8 | 960 | 7.5 | 58.75 | 47.94 |
| EPHHL | 35DAA | 23.5 | 43.8 | 960 | 7.5 | 56.25 | 47.81 |
| EPHHL | 35DAA | 30.2 | 76.3 | 960 | 7.5 | 83.75 | 77.94 |
| EPHHL | 35DAA | 36.0 | 77.5 | 960 | 7.5 | 90 | 79.12 |

TABLE 3
Weed control from post-emergence application of Cmpd 1 (Halauxifen-methyl) and
diclosulam premix when tank-mixed with glyphosate DMA.

| | | Cmpd 1 + | | Glyphosate | | Combination | |
|---|---|---|---|---|---|---|---|
| | | Diclosulam | | DMA salt | | | Predicted |
| | | | Mean % | | Mean % | Measured | mean % |
| Weed | Evaluation | | weed | | weed | mean % weed | weed |
| Bayer | Interval | g ai/ha | control | g ai/ha | control | control | control |
| ERIBO | 9DAA | 21.8 | 28.3 | 960 | 11.7 | 43.33 | 36.92 |
| ERIBO | 9DAA | 23.5 | 30.0 | 960 | 10.0 | 45 | 37.08 |
| ERIBO | 9DAA | 35.2 | 26.7 | 960 | 10.0 | 45 | 33.92 |
| ERIBO | 12DAA | 42.0 | 74.7 | 960 | 43.3 | 89.33 | 85.63 |
| ERIBO | 14DAA | 35.2 | 82.3 | 960 | 40.0 | 93.67 | 89.4 |
| ERIBO | 14DAA | 21.8 | 80.7 | 960 | 36.7 | 91 | 87.73 |
| ERIBO | 14DAA | 23.5 | 80.7 | 960 | 36.7 | 93.33 | 87.83 |
| ERIBO | 14DAA | 32.7 | 85.7 | 960 | 36.7 | 93.67 | 91 |
| ERIBO | 14DAA | 35.2 | 84.0 | 960 | 36.7 | 96 | 90 |
| ERIBO | 14DAA | 36.0 | 81.3 | 960 | 36.7 | 93 | 88.13 |
| ERIBO | 14DAA | 39.0 | 86.7 | 960 | 36.7 | 94.33 | 91.6 |
| ERIBO | 14DAA | 42.0 | 89.0 | 960 | 36.7 | 98 | 92.9 |
| ERIBO | 14DAA | 20.1 | 43.3 | 960 | 23.3 | 63.33 | 57.33 |
| ERIBO | 14DAA | 30.2 | 36.7 | 960 | 23.3 | 70 | 51.5 |
| ERIBO | 15DAA | 20.1 | 75.0 | 960 | 48.3 | 90.67 | 87.08 |
| ERIBO | 15DAA | 21.8 | 80.3 | 960 | 48.3 | 92.67 | 89.85 |
| ERIBO | 15DAA | 23.5 | 80.3 | 960 | 48.3 | 95 | 89.85 |
| ERIBO | 15DAA | 39.0 | 82.7 | 960 | 48.3 | 94.33 | 91 |
| ERIBO | 23DAA | 30.2 | 48.3 | 960 | 31.7 | 71.67 | 64.75 |
| ERIBO | 35DAA | 21.8 | 86.7 | 960 | 25.0 | 94.33 | 90.03 |
| ERIBO | 35DAA | 23.5 | 82.3 | 960 | 25.0 | 95.33 | 86.8 |
| ERIBO | 35DAA | 35.2 | 87.0 | 960 | 25.0 | 96 | 90.32 |
| ERIBO | 35DAA | 36.0 | 79.3 | 960 | 25.0 | 92 | 84.47 |
| ERIBO | 40DAA | 30.2 | 89.3 | 960 | 46.7 | 96.67 | 94.32 |
| ERIBO | 54DAA | 21.8 | 83.7 | 960 | 23.3 | 93.33 | 87.5 |
| ERIBO | 67DAA | 21.8 | 79.3 | 960 | 20.0 | 92.67 | 83.47 |
| ERIBO | 67DAA | 30.2 | 80.0 | 960 | 20.0 | 94 | 84 |
| ERIBO | 67DAA | 32.7 | 84.3 | 960 | 20.0 | 95 | 87.47 |
| ERIBO | 67DAA | 35.2 | 86.0 | 960 | 20.0 | 96 | 88.8 |
| ERIBO | 67DAA | 36.0 | 82.7 | 960 | 20.0 | 92 | 86.13 |
| ERIBO | 67DAA | 39.0 | 84.3 | 960 | 20.0 | 96.67 | 87.47 |

TABLE 4
Weed control from post-emergence application of Cmpd 1 (Halauxifen-methyl) and
diclosulam premix when tank-mixed with glyphosate DMA.

| | | Cmpd 1 + | | Glyphosate | | Combination | |
|---|---|---|---|---|---|---|---|
| | | Diclosulam | | DMA salt | | | Predicted |
| | | | Mean % | | Mean % | Measured | mean % |
| Weed | Evaluation | | weed | | weed | mean % | weed |
| Bayer | Interval | g ai/ha | control | g ai/ha | control | weed control | control |
| ERISU | 19DAA | 20.0 | 59.3 | 1200 | 19.0 | 76.33 | 67.13 |
| ERISU | 19DAA | 30.0 | 63.7 | 1200 | 19.0 | 88 | 70.57 |
| ERISU | 19DAA | 36.0 | 66.7 | 1200 | 19.0 | 85.67 | 72.93 |
| ERISU | 29DAA | 20.0 | 71.3 | 1200 | 17.0 | 86.33 | 76.26 |
| ERISU | 29DAA | 30.0 | 75.3 | 1200 | 17.0 | 89.33 | 79.52 |
| ERISU | 29DAA | 36.0 | 78.3 | 1200 | 17.0 | 87.67 | 82.02 |
| ERICA | 30DAA | 36.0 | 63.8 | 1200 | 28.8 | 81 | 74.12 |
| ERICA | 32DAA | 20.0 | 72.5 | 1200 | 32.5 | 91 | 81.12 |
| ERICA | 32DAA | 36.0 | 83.5 | 1200 | 32.5 | 95.5 | 88.7 |
| ERICA | 46DAA | 20.0 | 79.5 | 1200 | 25.0 | 95.75 | 84.4 |
| ERICA | 46DAA | 30.0 | 90.5 | 1200 | 25.0 | 99 | 92.95 |
| ERISU | 46DAA | 30.0 | 85.0 | 1200 | 15.7 | 93.33 | 87.23 |
| ERICA | 47DAA | 36.0 | 82.0 | 1200 | 28.8 | 93.5 | 87.55 |
| ERICA | 62DAA | 20.0 | 85.0 | 1200 | 20.0 | 97.75 | 87.75 |

What is claimed is:

1. A herbicidal tank mix composition comprising a herbicidally effective amount of (a) a compound of the formula (I) 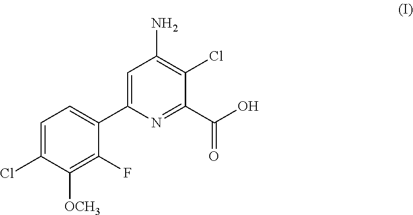 [SMILES: COc1c(Cl)ccc(-c2cc(N)c(Cl)c(C(=O)O)n2)c1F]
or an agriculturally acceptable salt or ester thereof (b) a triazolopyrimidine sulfonamide herbicide or an agriculturally acceptable salt or ester thereof, and (c) glyphosate or an agriculturally acceptable salt or ester thereof.

2. The composition of claim 1, wherein no additional herbicidal active ingredients are present in the composition.

3. The composition of claim 1, wherein (a) is a C₁-C₄ alkyl or benzyl ester of compound (I).

4. The composition of claim 3, wherein (a) is a methyl ester of compound (I).

5. The composition of claim 1, wherein (a) is the carboxylic acid of formula (I).

6. The composition of claim 1, wherein (a) is the methyl ester of the compound of formula (I) and (b) is selected from the group consisting of florasulam, cloransulam, diclosulam, flumetsulam, metosulam, penoxsulam, pyroxsulam, and agriculturally acceptable salts and esters thereof, and combinations thereof.

7. The composition of claim 1, wherein (b) is diclosulam or an agriculturally acceptable salt thereof and the weight ratio of the compound of (a) plus (b) to (c) is from about 1:1120 to about 0.54:1.

8. The composition of claim 7, wherein (b) is diclosulam or an agriculturally acceptable salt thereof and the weight ratio of (a) plus (b) to (c) is from about 1:320 to about 0.161:1.

9. The composition of claim 7, wherein (b) is diclosulam or an agriculturally acceptable salt thereof and the weight ratio of the compound of (a) plus (b) to (c) is from about 1:112 to about 0.06:1.

10. The composition of claim 1, wherein (b) is diclosulam or an agriculturally acceptable salt thereof and the weight ratio of the compound of (a) to (b) to (c) is from about 1:5:560 to about 1:2:67.

11. The composition of claim 10, wherein (b) is diclosulam or an agriculturally acceptable salt thereof and the weight ratio of (a) to (b) to (c) is from about 1:2.5:280 to about 1:2:75.

12. The composition of claim 10, wherein (b) is diclosulam or an agriculturally acceptable salt thereof and the weight ratio of the compound of (a) to (b) to (c) is from about 1:2:168 to about 1:1.5:84.

13. The composition of claim 1, wherein (b) is florasulam or an agriculturally acceptable salt thereof and the weight ratio of the compound of (a) plus (b) to (c) is from about 1:4480 to about 0.286:1.

14. The composition of claim 13, wherein (b) is florasulam or an agriculturally acceptable salt thereof and the weight ratio of (a) plus (b) to (c) is from about 1:747 to about 0.08:1

15. The composition of claim 13, wherein (b) is florasulam or an agriculturally acceptable salt thereof and the weight ratio of the compound of (a) plus (b) to (c) is from about 1:210 to about 0.031:1.

16. The composition of claim 1, wherein (b) is florasulam or an agriculturally acceptable salt thereof and the weight ratio of the compound of (a) to (b) to (c) is from about 2:1:1120 to about 1.67:1:112.

17. The composition of claim 16, wherein (b) is florasulam or an agriculturally acceptable salt thereof and the weight ratio of (a) to (b) to (c) is from about 2:1:560 to about 2:1:149.

18. The composition of claim 16, wherein (b) is florasulam or an agriculturally acceptable salt thereof and the weight ratio of the compound of (a) to (b) to (c) is from about 1.67:1:280 to about 3.2:1:268.

19. The composition of claim 1, wherein (b) is pyroxsulam or an agriculturally acceptable salt thereof and the weight ratio of the compound of (a) plus (b) to (c) is from about 1:3360 to about 0.357:1.

20. The composition of claim 19, wherein (b) is pyroxsulam or an agriculturally acceptable salt thereof and the weight ratio of (a) plus (b) to (c) is from about 1:560 to about 0.098:1.

21. The composition of claim 19, wherein (b) is pyroxsulam or an agriculturally acceptable salt thereof and the weight ratio of the compound of (a) plus (b) to (c) is from about 1:115 to about 0.046:1.

22. The composition of claim 1, wherein (b) is pyroxsulam or an agriculturally acceptable salt thereof and the weight ratio of the compound of (a) to (b) to (c) is from about 1:1:560 to about 1:1:67.

23. The composition of claim 22, wherein (b) is pyroxsulam or an agriculturally acceptable salt thereof and the weight ratio of (a) to (b) to (c) is from about 1:1:280 to about 1.2:1:90.

24. The composition of claim 22, wherein (b) is pyroxsulam or an agriculturally acceptable salt thereof and the weight ratio of the compound of (a) to (b) to (c) is from about 1:1.92:168 to about 1.07:1:90.

25. The composition of claim 1, wherein (b) is cloransulam or flumetsulam, or an agriculturally acceptable salt thereof, and the weight ratio of the compound of (a) plus (b) to (c) is from about 1:395 to about 0.536:1.

26. The composition of claim 25, wherein (b) is cloransulam or flumetsulam, or an agriculturally acceptable salt thereof and the weight ratio of (a) plus (b) to (c) is from about 1:187 to about 0.196:1.

27. The composition of claim 25, wherein (b) is cloransulam or flumetsulam, or an agriculturally acceptable salt thereof and the weight ratio of the compound of (a) to (b) to (c) is from about 1:84 to about 0.113:1.

28. The composition of claim 1, wherein (b) is cloransulam or flumetsulam, or an agriculturally acceptable salt thereof, and the weight ratio of the compound of (a) to (b) to (c) is from about 1:16:560 to about 1:2:67.2.

29. The composition of claim 28, wherein (b) is cloransulam or flumetsulam, or an agriculturally acceptable salt thereof and the weight ratio of (a) to (b) to (c) is from about 1:5:280 to about 1:2.67:75.

30. The composition of claim 28, wherein (b) is cloransulam or flumetsulam, or an agriculturally acceptable salt thereof and the weight ratio of the compound of (a) to (b) to (c) is from about 1:3:168 to about 1:3.75:84.

31. The composition of claim 1, wherein (b) is metosulam or an agriculturally acceptable salt thereof and the weight ratio of the compound of (a) plus (b) to (c) is from about 1:2240 to about 0.357:1.

32. The composition of claim 31, wherein (b) is metosulam or an agriculturally acceptable salt thereof and the weight ratio of (a) plus (b) to (c) is from about 1:678 to about 0.125:1.

33. The composition of claim 31, wherein (b) is metosulam or an agriculturally acceptable salt thereof and the weight ratio of the compound of (a) plus (b) to (c) is from about 1:240 to about 0.054:1.

34. The composition of claim 1, wherein (b) is metosulam or an agriculturally acceptable salt thereof and the weight ratio of the compound of (a) to (b) to (c) is from about 1:2:560 to about 1:1:67.

35. The composition of claim 34, wherein (b) is metosulam or an agriculturally acceptable salt thereof and the weight ratio of (a) to (b) to (c) is from about 1.14:1:320 to about 1:1:75.

36. The composition of claim 34, wherein (b) is metosulam or an agriculturally acceptable salt thereof and the weight ratio of the compound of (a) to (b) to (c) is from about 2.5:1:420 to about 1:1.25:84.

37. The composition of claim 1, wherein (b) is penoxsulam or an agriculturally acceptable salt thereof and the weight ratio of the compound of (a) plus (b) to (c) is from about 1:1120 to about 0.446:1.

38. The composition of claim 37, wherein (b) is penoxsulam or an agriculturally acceptable salt thereof and the weight ratio of (a) plus (b) to (c) is from about 1:389 to about 0.161:1.

39. The composition of claim 37, wherein (b) is penoxsulam or an agriculturally acceptable salt thereof and the weight ratio of the compound of (a) plus (b) to (c) is from about 1:168 to about 0.083:1.

40. The composition of claim 1, wherein (b) is penoxsulam or an agriculturally acceptable salt thereof and the weight ratio of the compound of (a) to (b) to (c) is from about 1:5:560 to about 1:2:67.

41. The composition of claim 40, wherein (b) is penoxsulam or an agriculturally acceptable salt thereof and the weight ratio of (a) to (b) to (c) is from about 1:2.5:280 to about 1:1.67:75.

42. The composition of claim 40, wherein (b) is penoxsulam or an agriculturally acceptable salt thereof and the weight ratio of the compound of (a) to (b) to (c) is from about 1:1.5:168 to about 1:2.4:84.

43. The composition of claim 1, further comprising a herbicide safener.

44. The composition of claim 1, further comprising an agriculturally acceptable adjuvant or carrier.

45. A method of controlling undesirable vegetation which comprises applying a herbicidally effective amount of a herbicidal composition comprising:
(a) a compound of the formula (I) 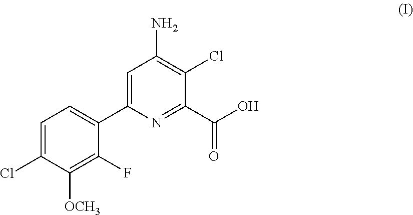 [SMILES: COc1c(Cl)ccc(-c2cc(N)c(Cl)c(C(=O)O)n2)c1F]
or an agriculturally acceptable salt or ester thereof,
(b) a triazolopyrimidine sulfonamide herbicide or an agriculturally acceptable salt or ester thereof, and (c) glyphosate or an agriculturally acceptable salt or ester thereof.

46. The method of claim 45, wherein no additional herbicidal active ingredients are present in the composition.

47. The method of claim 45, wherein the undesirable vegetation is controlled in soybean, cotton, sunflower, winter/spring oilseed rape, winter/spring canola, vegetables, ornamentals, rice, wheat, teff, triticale, barley, oats, rye, sorghum, corn/maize, sunflower, row crops, pastures, grasslands, rangelands, fallowland, fallow bed, sugarcane, turf, tree and vine orchards, aquatics, forestry, industrial vegetation management (IVM) and rights-of-way; burndown and control of weeds in fallow fields and fallow beds between the planting of crops, such as soybean, corn, cotton, sunflower, cereals, rice, winter/spring oilseed rape, winter/spring canola, corn/maize and sorghum.

48. The method of claim 45, wherein the composition is applied for burndown and control of undesirable vegetation in fallow weeds.

49. The method of claim 45, wherein the composition is used to control weeds just prior to or after planting soybeans.

50. The method of claim 45, wherein the undesirable vegetation is immature.

51. The method of claim 45 wherein the (a) and (b) are applied pre-emergence to the weed or the crop.

52. The method of claim 45, wherein the (a) and (b) are applied post-emergence to the weed or the crop.

53. The method of claim 45, wherein the undesirable vegetation is controlled in a crop that is tolerant to glyphosate, glufosinate, dicamba, phenoxy auxins, pyridyloxy auxins, aryloxyphenoxypropionates, acetyl CoA carboxylase (ACCase) inhibitors, imidazolinones, acetolactate synthase (ALS) inhibitors, 4-hydroxyphenyl-pyruvate dioxygenase (HPPD) inhibitors, protoporphyrinogen oxidase (PPO) inhibitors, triazines, or bromoxynil.

54. The method of claim 53, wherein the tolerant crop possesses single or multiple or stacked traits conferring tolerance to single or multiple herbicides or single or multiple modes of action.

55. The method of claim 45, wherein the undesirable vegetation comprises a herbicide resistant or tolerant weed.

56. The method of claim 55, wherein the resistant or tolerant weed is a biotype with resistance or tolerance to single or multiple herbicides, single or multiple chemical classes, or single or multiple herbicide modes of action.

57. The method of claim 56, wherein the resistant or tolerant weed is a biotype resistant or tolerant to acetolactate synthase (ALS) inhibitors, photosystem II inhibitors, acetyl CoA carboxylase (ACCase) inhibitors, synthetic auxins, photosystem I inhibitors, 5-enolpyruvylshikimate-3-phosphate (EPSP) synthase inhibitors, microtubule assembly inhibitors, lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes of action, quinclorac, arylaminopropionic acids, difenzoquat, endothall, or organoarsenicals.

58. The method of claim 45, wherein the undesirable vegetation is Commelina benghalensis L. (tropical spiderwort, COMBE), Conyza canadensis (horseweed/marestail, ERICA), Conyza bonariensis (fleabane, ERIBO), Echinochloa crus-galli (L.) P. Beauv. (barnyardgrass, ECHCG), Euphorbia heterophylla L. (wild poinsettia, EPHHL), Conyza sumatrensis (Guernsey fleabane, ERISU) and Ipomoea grandifolia (Corda-de-viola, IAQGR).

59. A herbicidal system comprising a first container comprising a premix or concentrate comprising a compound of formula (I) 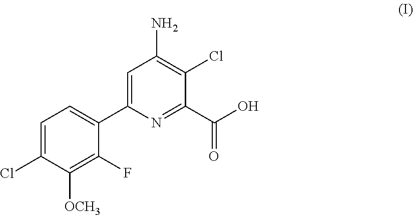 [SMILES: COc1c(Cl)ccc(-c2cc(N)c(Cl)c(C(=O)O)n2)c1F]
or an agriculturally acceptable salt or ester thereof and a triazolopyrimidine sulfonamide herbicide or an agriculturally acceptable salt or ester thereof, and a second container comprising a concentrate of glyphosate or an agriculturally acceptable salt or ester thereof.

60. The system of claim 59, wherein the first and/or second container contains one or more adjuvants and/or carriers.
